(19) United States
(12) Patent Application Publication
(10) Pub. No.: US 2012/0291109 A1
(43) Pub. Date: Nov. 15, 2012

(54) USER INFORMATION UTILIZATION SYSTEM, DEVICE, METHOD, AND PROGRAM

(75) Inventor: Takeaki Minamizawa, Minato-ku (JP)

(73) Assignee: NEC Corporation, Minato-ku, Tokyo (JP)

(21) Appl. No.: 13/519,505

(22) PCT Filed: Dec. 1, 2010
(86) PCT No.: PCT/JP2010/007004

§ 371 Date: Jun. 27, 2012

(30) Foreign Application Priority Data
Dec. 28, 2009 (JP) 2009-298851

(51) Int. Cl. G06F 21/00

(52) U.S. Cl. 726/6

(57) ABSTRACT

A user information utilization system includes: a user information storage means that stores user information; a temporary ID acquisition means that acquires a temporary ID for identifying the identicalness of a user between a plurality of devices or a plurality of service providers, the temporary ID being an identifier corresponding to a user of the stored user information; a user information comparing/determining means that compares legitimately-read user information of a plurality of users read in response to acquired two or more temporary IDs and a user information comparison/determination request that designates a predetermined condition that represents a desired relationship between a plurality of users represented by the two or more temporary IDs to thereby determine whether the relationship between the designated users satisfies the predetermined condition, and outputs the determination result; and a process execution means that receives the comparison/determination result for the user information and executes a predetermined process based on the received comparison/determination result.

### TECHNICAL FIELD

The present invention relates to a user information utilization system, a user information determining device, a user information utilization device, a user information utilization method, a user information determining program, and a user information utilization program for utilizing user information between a plurality of devices or a plurality of service providers.

### BACKGROUND ART

In recent years, development of single sign-on technologies is actively performed in order to simplify management of user accounts of Web services which are increasing explosively. For example, OpenID defined by OpenID Foundation, Security Assertion Markup Language (SAML) defined by Liberty Alliance, and the like are known.

A basic function of single sign-on involves associating IDs between an ID provider (hereinafter referred to as an associated ID providing device) that manages user IDs in an integrated manner and a service device that provides Web services to allow the associated ID providing device to execute login processes to respective Web services in an integrated manner. Thus, the users can simplify the login processes to respective Web services.

These standardization organizations are considering utilization of user information by providing user information stored in respective Web service providers to other Web service providers using the ID information managed by the associated ID providing device.

In relation to the technology of allowing user information to be used by a plurality of service providers, for example, Patent Literature 1 discloses a user information distributing system which filters and releases information based on a release control policy and an information request policy of service providers and/or users.

### CITATION LIST

### Patent Literature

PLT 1: Japanese Patent Application Laid-Open No. 2004-362189

### SUMMARY OF INVENTION

### Technical Problem

However, in the above-described method, a Web service provider who wants to use user information in its service needs to acquire the user information from a Web service provider storing the user information, which increases the risk of information management for the Web service provider who wants to use the user information in its service.

The invention has been made in view of the above problem, and an object of the invention is to provide a user information utilization system, a user information determining device, a user information utilization device, a user information utilization method, a user information determining program, and a user information utilization program capable of allowing a service provider who wants to use user information in its service to use the user information without acquiring the user information.

### Solution to Problem

A user information utilization system according to the invention is characterized by including: a user information storage means that stores user information; a temporary ID acquisition means that acquires a temporary ID for identifying the identicalness of a user between a plurality of devices or a plurality of service providers, the temporary ID being an identifier corresponding to a user of the user information stored in the user information storage means; a user information determining means that receives two or more temporary IDs acquired by the temporary ID acquisition means and a predetermined condition representing a desired relationship between a plurality of users represented by the two or more temporary IDs and outputs a determination result representing whether the user information of the users corresponding to the received temporary IDs satisfies the predetermined condition; and a process execution means that receives the determination result on the user information by the user information determining means and executes a predetermined process based on the received determination result.

A user information determining device according to the invention is capable of reading user information legitimately from a user information storage means that stores user information, and characterized by including: a user information determining means that receives two or more temporary IDs which are identifiers for identifying the identicalness of a user between a plurality of devices or a plurality of service providers, the identifier corresponding to the user of the user information stored in the user information storage means, and a predetermined condition representing a desired relationship between a plurality of users indicated by the two or more users and outputs a determination result representing whether the user information of the user corresponding to the received temporary ID satisfies the predetermined condition.

A user information utilization device according to the invention is capable of communicating with a user information determining device that legitimately acquires user information from a user information storage means that stores user information and provides a user information determination service, and characterized by including: a temporary ID acquisition means that acquires a temporary ID for identifying the identicalness of a user between a plurality of devices or a plurality of service providers, the temporary ID being an identifier corresponding to a user of the user information stored in the user information storage means; a user information determination requesting means that sends a user information determination request to the user information determining device by designating two or more temporary IDs acquired by the temporary ID acquisition means and a predetermined condition representing a desired relationship between a plurality of users indicated by the two or more temporary IDs; and a process execution means that executes a predetermined process based on the determination result on the user information obtained by the user information determination requesting means.

A user information utilization method according to the invention is characterized by including: allowing a user information utilization device, which is an information processing device that wants to utilize user information, to send a user information determination request to a user information permitting device, which is an information processing device capable of accessing a user information storage means storing user information, by designating two or more temporary IDs which are identifiers for identifying the identicalness of a user between a plurality of devices or a plurality of service providers and a predetermined condition representing a desired relationship between a plurality of users indicated by the two or more temporary IDs; allowing a user information permitting device having received the request to output a determination result representing whether the user information of the user corresponding to the designated temporary ID satisfies the predetermined condition as the user information determination process; and allowing the user information utilization device to receive the determination result on the user information by the user information permitting device and execute a predetermined process based on the received determination result.

A user information determining program according to the invention is characterized by allowing a computer capable of legitimately reading user information from a user information storage means that stores user information to execute: a user information determination process of receiving two or more temporary IDs corresponding to users of the user information stored in the user information storage means, provided from a temporary ID providing device that provides a temporary ID which is an identifier for identifying the identicalness of a user between a plurality of devices or a plurality of service providers and a predetermined condition representing a desired relationship between a plurality of users indicated by the two or more temporary IDs and outputting a determination result representing whether the user information of the users corresponding to the received temporary IDs satisfies the predetermined condition.

A user information utilization program according to the invention is characterized by allowing a computer capable of communicating with a user information determining device that legitimately acquires user information from a user information storage means that stores user information and provides a user information determination service to execute: a temporary ID acquisition process of acquiring a temporary ID which is an identifier for identifying the identicalness of a user between a plurality of devices or a plurality of service providers, the identifier corresponding to a user of the user information stored in the user information storage means; a user information determination requesting process of sending a user information determination request to the user information determining device by designating two or more temporary IDs acquired by the temporary ID acquisition process and a predetermined condition representing a desired relationship between a plurality of users indicated by the two or more temporary IDs; and a comparison/determination result receiving process of receiving a determination result on the user information obtained by the request.

### Advantageous Effects of Invention

According to the invention, since a service provider that uses user information can utilize the user information without acquiring the user information, it is possible to lessen the risk of infringing personal information protection. Moreover, it becomes easy to obtain the user's approval.

### BRIEF DESCRIPTION OF DRAWINGS

FIG. 1 is a block diagram illustrating a configuration example of a user information utilization system according to a first exemplary embodiment.

FIG. 2 is an explanatory diagram illustrating an example of the data stored in an associated ID utilizing unit 11.

FIG. 3 is an explanatory diagram illustrating an example of the data stored in a service executing unit 13.

FIG. 4 is an explanatory diagram illustrating an example of the data stored in an associated ID utilizing unit 21.

FIG. 5 is an explanatory diagram illustrating an example of the data stored in a user information storage unit 23 of a user information comparing device 20.

FIG. 6 illustrates an example of the data stored in an associated ID providing unit 51.

FIG. 7 is a sequence diagram illustrating an example of the operation of the first exemplary embodiment.

FIG. 8 is a sequence diagram illustrating an example of the operation of the first exemplary embodiment.

FIG. 9 is a sequence diagram illustrating an example of the operation of the first exemplary embodiment.

FIG. 10 is a block diagram illustrating a configuration example of a user information utilization system according to a second exemplary embodiment.

FIG. 11 is an explanatory diagram illustrating an example of the data stored in an anonymous communication user information storage unit 15.

FIG. 12 is an explanatory diagram illustrating an example of the data stored in an anonymous communication service executing unit 14.

FIG. 13 is a sequence diagram illustrating an example of the operation of the second exemplary embodiment.

FIG. 14 is a sequence diagram illustrating an example of the operation of the second exemplary embodiment.

FIG. 15 is a sequence diagram illustrating an example of the operation of the second exemplary embodiment.

FIG. 16 is a block diagram illustrating a configuration example of a user information utilization system according to a third exemplary embodiment.

FIG. 17 is a sequence diagram illustrating an example of the operation of the third exemplary embodiment.

FIG. 18 is a sequence diagram illustrating an example of the operation of the third exemplary embodiment.

FIG. 19 is an explanatory diagram illustrating an overview of the invention.

### DESCRIPTION OF EMBODIMENTS

### First Exemplary Embodiment

Hereinafter, exemplary embodiments of the invention will be described with reference to the drawings. In the present exemplary embodiment, an example in which the right of a one-week free access video service is transferred from a child to a father utilizing the user information stored in another service provider will be described.

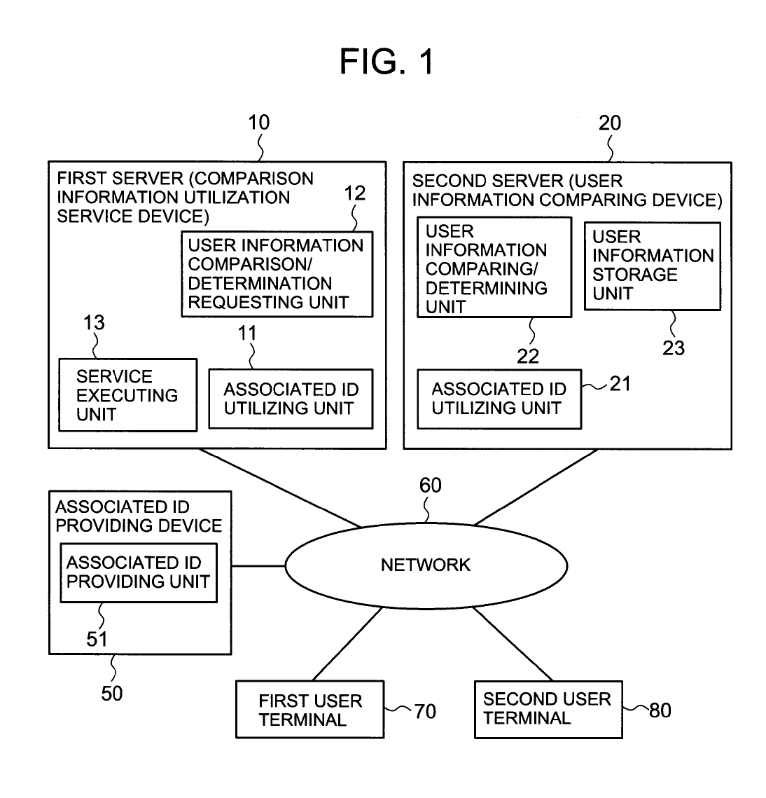

FIG. 1 is a block diagram illustrating a configuration example of a user information utilization system according to the first exemplary embodiment. The user information utilization system illustrated in FIG. 1 includes a first server 10, a second server 20, an associated ID providing device 50, a first user terminal 70, and a second user terminal 80. The respective devices are connected through a network 60 such as the Internet or a Next Generation Network (NGN). The connection to the network may be realized by a wired method or a wireless method. The number of user terminals may be one or three or more as long as it is a user terminal used by the user using the present system.

In the present exemplary embodiment, it is assumed that the first server 10 (hereinafter referred to as a comparison information utilization service device 10) that provides a video service and the second server 20 (hereinafter referred to as a user information comparing device 20) that manages the user information and provides a comparison/determination service are operated by different service providers. That is, the comparison information utilization service device 10 performs a process of transferring a video service using the user information stored in the user information comparing device 20.

The first user terminal 70 and the second user terminal 80 are information processing terminals such as a PC or a mobile phone and exchange information with various servers (more specifically, the associated ID providing device 50, the comparison information utilization service device 10, or the user information comparing device 20) using a browser or the like. The browser is an application that acquires and displays a moving image of a video or the like and the contents of a home page or the like from a WWW server or the like in accordance with a hypertext transfer protocol (HTTP).

The associated ID providing device 50 includes an associated ID providing unit 51 and performs a login process of a user terminal to the comparison information utilization service device 10 and the user information comparing device 20. The associated ID providing unit 51 generates an associated ID for identifying the logged-in user for each of the comparison information utilization service device 10 and the user information comparing device 20. That is, an associated ID for identifying the logged-in user in the server is generated for each of the login destination servers. Here, the associated ID is an identifier (user ID) assigned to each user in order to identify the identicalness of a user between a plurality of devices or a plurality of service providers. In the present exemplary embodiment, the associated ID represents an identifier for identifying the identicalness of a user between the associated ID providing device 50 and the login destination server. The associated ID belongs to a temporary ID in a broader sense of its meaning, and is sometimes referred to as a Name ID or a global ID. The temporary ID represents an identifier different from a user ID used by respective devices or respective service providers, assigned in order to identify the identicalness of a user between a plurality of devices or a plurality of service providers. Moreover, the Name ID is a user identification ID defined by Liberty Alliance and is used to designate the same user between an ID Provider (IdP) and a Service Provider (SP). Moreover, the global ID is a user identification ID designed by OpenID Foundation, and is used to designate the same user between OpenID Provider (OP) and Relying Party (RP).

Moreover, in the invention, although a target to which such an ID is assigned is a user (person), when a user is uniquely specified to each user terminal, the user ID may be assigned to the user terminal. In such a case, “user” that is the target to which the user ID is assigned in the following description may be substituted with “user terminal.”

When a user ID which allows the identicalness of a user to be directly identified between the comparison information utilization service device 10 and the user information comparing device 20 is assigned in advance as a temporary ID, for example, the associated ID providing device 50 may not be provided. However, since the invention assumes that information is exchanged between service providers to which user information is to be concealed, it is more preferable to use an ID association by the associated ID providing device 50 as in the case of the present exemplary embodiment rather than allowing the identicalness of a user to be directly identified by the using side and the providing side.

As described above, the comparison information utilization service device 10 is a server that provides a video service. Moreover, the comparison information utilization service device 10 has a function of determining the validity of a received request by utilizing user information upon receiving the request for transferring the right of a video service to another user. The comparison information utilization service device 10 includes an associated ID utilizing unit 11, a user information comparison/determination requesting unit 12, and a service executing unit 13.

The associated ID utilizing unit 11 stores an associated ID that correlates an (identifiable) user managed by the comparison information utilization service device 10 and a user managed by the associated ID providing device 50. In the present exemplary embodiment, the user ID in the comparison information utilization service device 10 and the associated ID provided from the associated ID providing device 50 in relation to the user ID are stored in correlation.

The service executing unit 13 executes the service that the comparison information utilization service device 10 provides to the user terminal. In the present exemplary embodiment, the moving image of a video is provided (data is transmitted) in response to the request from the browser of the user terminal. Moreover, the service executing unit 13 has a function of requesting the user information comparison/determination requesting unit 12 described later to determine the relation between a transferor user and a transferee user in order to determine the validity of the transfer to the transferee user upon receiving the request for transferring the service provided to the user of the user terminal from the user terminal.

The user information comparison/determination requesting unit 12 sends a user information comparison/determination request to the user information comparing device 20. In the present exemplary embodiment, by the request from the service executing unit 13, the user information comparison/determination request is sent to request the user information comparing device 20 to determine the relation between the transferor user and the transferee user of the video service.

Moreover, as described above, the user information comparing device 20 is a server that manages user information and provides a comparison/determination service. Moreover, in the present exemplary embodiment, the user information comparing device 20 has a function of comparing and determining the relation between the designated users in response to the request from the comparison information utilization service device 10. The user information comparing device 20 includes an associated ID utilizing unit 21, a user information comparing/determining unit 22, and a user information storage unit 23. The associated ID utilizing unit 21 of the user information comparing device 20 stores the associated ID provided from the associated ID providing device 50. The associated ID provided from the associated ID providing device 50 and the user ID in the user information comparing device 20 may be stored in correlation.

The user information comparing/determining unit 22 executes a comparison/determination service using a plurality of sets of user information stored in the user information storage unit 23 described later. More specifically, the user information comparing/determining unit 22 determines whether the relation between the designated users satisfies a designated condition (hereinafter referred to as a comparison condition). Here, the comparison condition defines the relation between a plurality of users and represent a desired relation, which is an allowable range, between a plurality of target users. For example, when the user information includes information on a Web service system, the comparison condition may be “the connection between persons in a social networking service is realized by user connection of n steps or smaller” or “the users belong to the same community.” Moreover, for example, when the user information includes personnel information, the comparison condition may be “the users work in the same company,” “the users are in the same group of the same company,” or “the users work in the same work place of the same company.” Moreover, for example, when the user information includes position information or schedule information, the comparison condition may be “the users are at the same position (within a range where they are sensed by a near-field communication function of a mobile phone)” or “the users have met within n months.” Moreover, when the user information includes information on communication sessions, the comparison condition may be “the users have exchanged calls or mails n times or more within n months.”

Since the comparison condition is a condition for determining the relation between users while concealing the content of the user information, the comparison condition does not include a condition in which the content of the user information is directly compared. For example, a comparison condition that “an age gap between two designated users A and B is n years or more” is admitted, but a comparison condition that “both of two designated users A and B are n years old or more” or a comparison condition that “both of two designated users A and B belong to XX community” is not admitted. If a comparison condition in which the content of the user information is directly compared is admitted, there is a concern that the content of the user information is identified when the comparison and determination are repeated.

The user information storage unit 23 stores user information which is to be managed by a service provider operating the user information comparing device 20. The user information storage unit 23 stores user information of respective users in correlation with the user ID in the user information comparing device 20, for example. In this example, it is assumed that individual information of the user such as a name or an address and information representing the relation to other users are stored as the user information, for example. It is not necessary to store the information directly representing the relation, but only information which allows the relation between users to be determined may be stored. For example, if a specification in which whether users are members of the same family or not is determined by using only their addresses and names is used, the user information may include only an address and a name.

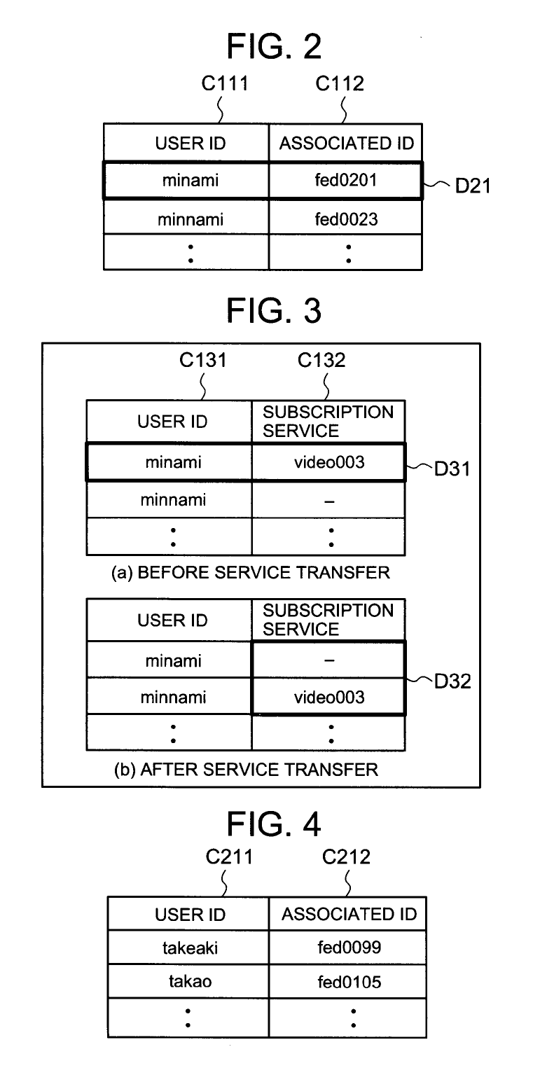

Next, the data stored in each unit of the present exemplary embodiment will be described. FIG. 2 is an explanatory diagram illustrating an example of the data stored in the associated ID utilizing unit 11 of the comparison information utilization service device 10. FIG. 2 illustrates an example of the structure of the data stored in the associated ID utilizing unit 11, which includes a user ID (C111) in the comparison information utilization service device 10 and an associated ID (C112) provided from the associated ID providing device 50. The user ID (C111) is an ID for uniquely identifying the user in the comparison information utilization service device 10. The associated ID (C112) is an ID for uniquely identifying the user between the associated ID providing device 50 and the comparison information utilization service device 10. FIG. 2 illustrates an example in which an associated ID “fed0201” and a user ID “minami” are stored in correlation, for example. Moreover, an example in which an associated ID “fed0023” and a user ID “minnami” are stored in correlation is illustrated, for example.

FIG. 3 is an explanatory diagram illustrating an example of the data stored in the service executing unit 13. FIG. 3(a) illustrates an example of the data before service transfer and FIG. 3(b) illustrates an example of the data after service transfer. FIG. 3 illustrates an example of the structure of the data stored in the service executing unit 13, which includes a user ID (C131) in the comparison information utilization service device 10 and a subscription service (C132) of the user. The user ID (C131) is an ID for uniquely identifying the user in the comparison information utilization service device 10 and is the same information as the user ID (C111). The subscription service is an identifier representing a service which the user subscribes to. FIG. 3(a) illustrates an example in which a user ID “minami” and a subscription service “video003” are stored in correlation, for example. Moreover, an example in which a user ID “minnami” and a subscription service “-(null)” are stored in correlation is illustrated, for example. The data required by the respective units within the device may be collectively managed as the user information of the comparison information utilization service device 10.

FIG. 4 is an explanatory diagram illustrating an example of the data stored in the associated ID utilizing unit 21 of the user information comparing device 20. FIG. 4 illustrates an example of the structure of the data stored in the associated ID utilizing unit 21, which includes a user ID (C211) in the user information comparing device 20 and an associated ID (C212) provided from the associated ID providing device 50. The associated ID (C212) is an ID for uniquely identifying the user between the associated ID providing device 50 and the user information comparing device 20. FIG. 2 illustrates an example in which an associated ID “fed0099” and a user ID “takeaki” are stored in correlation, for example. Moreover, an example in which an associated ID “fed0105” and a user ID “takao” are stored in correlation is illustrated, for example.

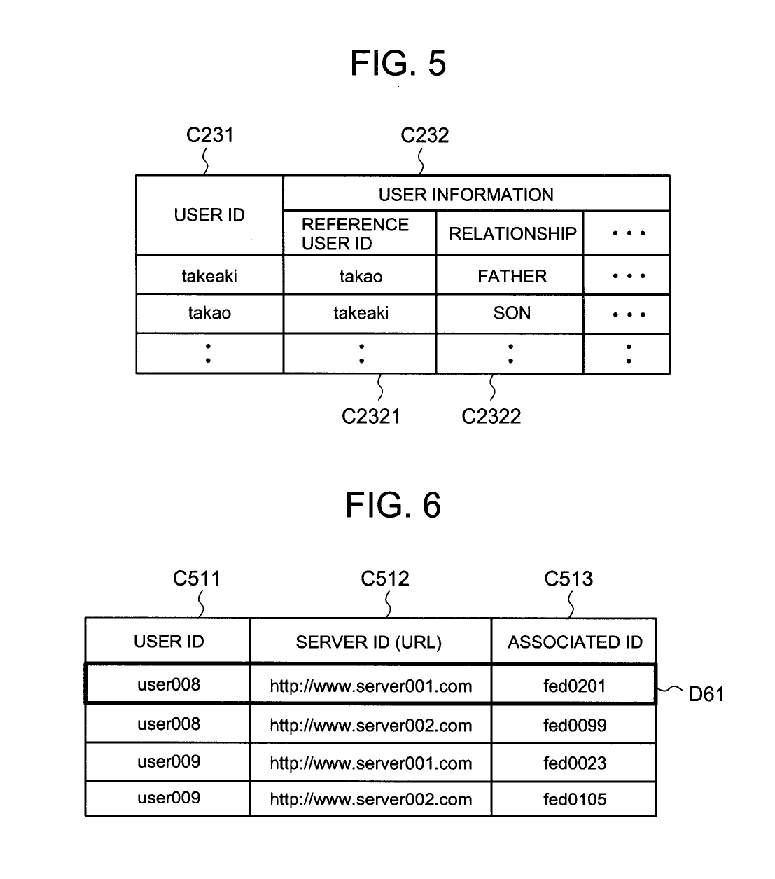

FIG. 5 is an explanatory diagram illustrating an example of the data (user information) stored in the user information storage unit 23 of the user information comparing device 20. FIG. 5 illustrates an example in which user information (C232) is stored in correlation with a user ID (C231) in the user information comparing device 20. Moreover, an example in which the user information (C232) includes a reference user ID (C2321) and relation (C2322) is illustrated. The user ID (231) is an ID for uniquely identifying the user in the user information comparing device 20. In the reference user ID (C2321), a user ID that indicates the user having a relation with the relation (C2322) appearing after that is registered. In the relation (C2322), the relation with a user indicated by the reference user ID seen from the corresponding user (a user indicated by the user ID correlated with the corresponding record) is registered. FIG. 5 illustrates an example in which a user ID “takeaki,” a reference user ID “takao,” and a relation “FATHER” are stored in correlation, for example. Moreover, an example in which a user ID “takao,” a reference user ID “takeaki,” and a relation “SON” are stored in correlation is illustrated, for example. That is, the user information illustrated in FIG. 5 represents that the user ID “takao” is a father as seen from the user ID “takeaki,” and the user ID “takeaki” is a son as seen from the user ID “takao.” In the example illustrated in FIG. 5, although only one combination of a reference user ID and a relation is stored for one user ID, a plurality of combinations may be stored for one user ID. Moreover, rather that registering the combination of a reference user ID and a relation, a data structure in which user IDs having a family relation are registered may be used.

FIG. 6 is an explanatory diagram illustrating an example of the data stored in the associated ID providing unit 51 of the associated ID providing device 50. FIG. 6 illustrates an example of the structure of the data stored in the associated ID providing unit 51, which includes a user ID (C511) in the associated ID providing device 50, a server ID (C512), and an associated ID (C513). The user ID (C511) is an ID for uniquely identifying the user in the associated ID providing device 50. The server ID (C512) is information representing a server which a logged-in user accesses through the associated ID providing device 50, and in this example, a URL is used. The associated ID (C513) is an ID for uniquely identifying the user between the associated ID providing device 50 and an access destination server.

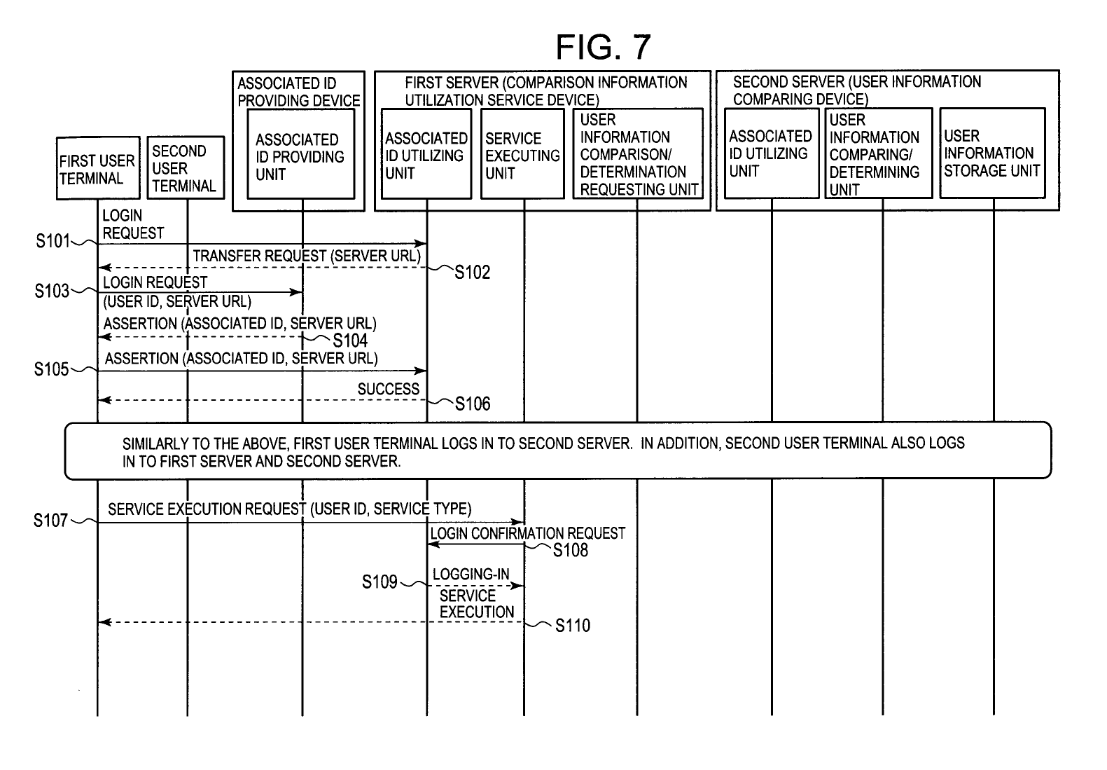

Next, the operation of the present exemplary embodiment will be described. FIGS. 7 to 9 are sequence diagrams illustrating an example of the operation of the present exemplary embodiment. FIGS. 7 to 9 are a series of sequence diagrams, and a message indicated by a broken-line arrow represents a response to a received request.

First, a user accesses the comparison information utilization service device 10 in order to receive a service provided by the comparison information utilization service device 10 through the first user terminal 70 owned by the user. In this case, the first user terminal 70 sends a login request to the comparison information utilization service device 10 in accordance with the user operation (S101 of FIG. 7).

In the present exemplary embodiment, upon receiving the login request, the associated ID utilizing unit 11 of the comparison information utilization service device 10 sends a login request transmission instruction to transmit the login request transmission to the associated ID providing device 50 to the first user terminal 70 in order to allow the user to log in with a single sign-on (S102). In this example, it is assumed that the login request transmission instruction includes a URL “http://www.server001.com” as a server ID representing the comparison information utilization service device 10.

The first user terminal 70 transmits the login request to the associated ID providing unit 51 of the associated ID providing device 50 (S103). In the present exemplary embodiment, it is assumed that the login request includes a user ID “user008” representing the owner of the first user terminal in the associated ID providing device 50 and the URL “http://www.server001.com” of the comparison information utilization service device 10.

In the present exemplary embodiment, it is assumed that respective users use different user IDs for respective access destination devices depending on the user terminal owned by each user. In this example, the first user terminal 70 uses a user ID “user008” for the associated ID providing device 50, uses a user ID “minami” for the comparison information utilization service device 10, and uses a user ID “takeaki” for the user information comparing device 20. Moreover, the second user terminal 80 uses a user ID “user009” for the associated ID providing device 50, uses a user ID “minnami” for the comparison information utilization service device 10, and uses a user ID “takao” for the user information comparing device.

Generally, authentication information such as a password for allowing the associated ID providing device 50 to authenticate the user is also included in the login request transmission instruction. In the present exemplary embodiment, it is assumed that all login requests are successfully authenticated, and description of authentication information will not be provided.

The associated ID providing unit 51 of the associated ID providing device 50 authenticates the first user terminal 70 based on the received authentication information. When the authentication is successful, a successfully authenticated user ID, a server ID which is the transmitter of the login request transmission instruction, and an associated ID for identifying the successfully authenticated user between the server and the associated ID providing device 50 are registered in a table stored in the associated ID providing unit 51. In this example, the user ID “user008,” the server ID (URL) “http://www.server001.com,” and the associated ID “fed0201” are registered in correlation (see D61 of FIG. 6).

When registration of the associated ID is completed, the associated ID providing unit 51 sends an assertion representing the login success to the first user terminal 70 which is the login requester (S104). In the assertion, the URL “http://www.server001.com” of the access destination server and the provided associated ID “fed0201” are stored.

The first user terminal 70 having received the assertion transmits the assertion to the comparison information utilization service device 10 (S105).

The associated ID utilizing unit 11 of the comparison information utilization service device 10 having received the assertion recognizes the completion of login by the reception of the assertion (S106). Moreover, the user ID “minami” representing the user of the first user terminal 70 in the comparison information utilization service device 10 and the associated ID “fed0201” provided from the associated ID providing device 50 are registered in the table stored in the associated ID utilizing unit 11 in correlation (see D21 of FIG. 2).

Moreover, the first user terminal 70 performs a login process with respect to the user information comparing device 20 similarly to the case of the comparison information utilization service device 10. Furthermore, the second user terminal 80 performs a login process with respect to the comparison information utilization service device 10 and the user information comparing device 20 similarly to the first user terminal 70.

In this way, the table stored in the associated ID utilizing unit 11 of the comparison information utilization service device 10, the table stored in the associated ID utilizing unit 21 of the user information comparing device 20, and the table stored in the associated ID providing unit 51 of the associated ID providing device 50 are updated (see FIGS. 2, 4, and 6). In this example, “fed0201” and “fed0023” are provided to the comparison information utilization service device 10 as associated IDs correlated with the user IDs “minami” and “minnami,” respectively. Moreover, “fed0099” and “fed0105” are provided to the user information comparing device 20 as associated IDs correlated with the user IDs “takeaki” and “takao,” respectively.

Subsequently, the first user terminal 70 transmits a service execution request to the comparison information utilization service device 10 in order to receive a service provided by the comparison information utilization service device 10 (S107). The service execution request includes the user ID “minami” in the comparison information utilization service device 10 of the first user terminal 70 which is the requestor and “video003” representing the type of a service to be executed, for example.

The service executing unit 13 of the comparison information utilization service device 10 having received the service execution request transmits a login confirmation request including the requestor user ID “minami” to the associated ID utilizing unit 11 in order to check whether the user has logged in (S108).

Upon checking whether the designated user ID has logged in, the associated ID utilizing unit 11 sends the result of checking to the service executing unit 13 (S109). In the present exemplary embodiment, since the associated ID “fed0201” corresponding to the user ID “minami” is present in the table stored in the associated ID utilizing unit 11, the associated ID utilizing unit 11 sends a note indicating the user ID has been logging in to the service executing unit 13.

The service executing unit 13 having recognized that the user ID has been logging in executes a service after checking whether the user has subscribed to the requested service (S110). In the present exemplary embodiment, when the user ID “minami” requests the service type “video003,” since the subscription service “video003” can be resolved from the user ID “minami” of the table stored in the service executing unit 13, it is determined that the user has subscribed to the requested service (see D31 of FIG. 3), and the requested video service is executed in the user terminal 70. For example, a movie on demand is distributed.

Subsequently, the user of the first user terminal 70 performs an operation of transferring the service received from the comparison information utilization service device 10 to another user. In the present exemplary embodiment, an example in which the right of a one-week free access video service is transferred from a child to a parent will be described.

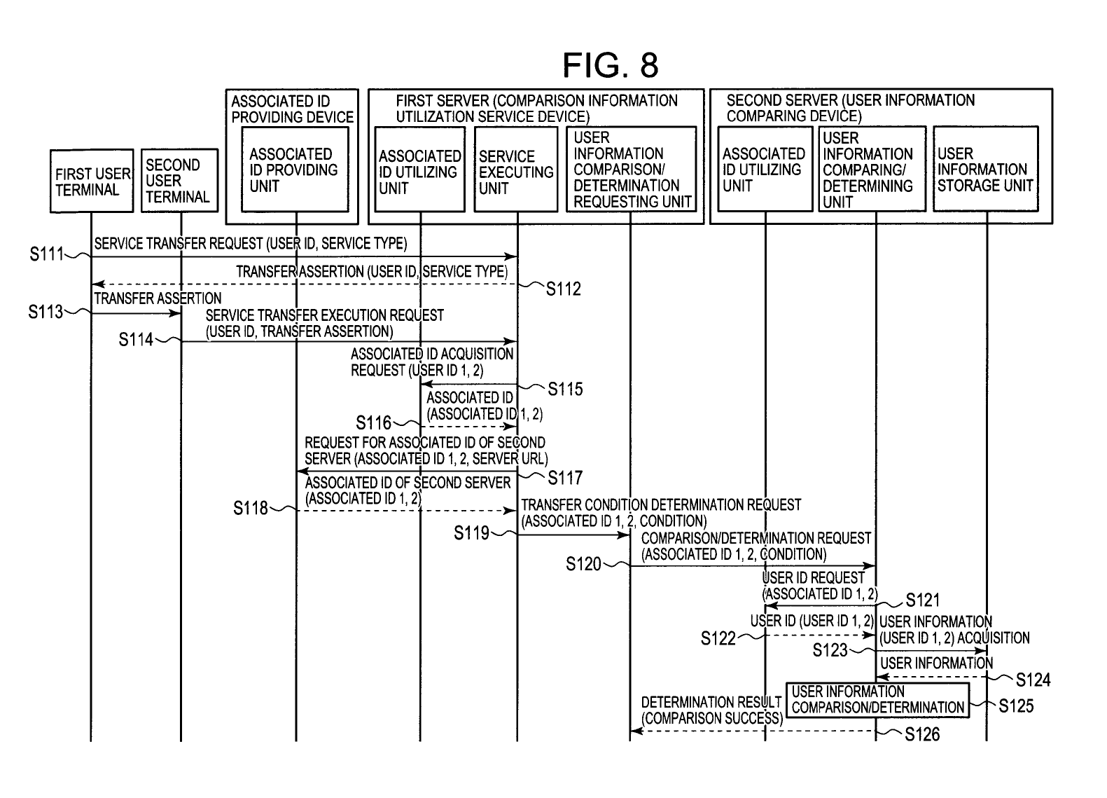

The first user terminal 70 transmits a service transfer request to the comparison information utilization service device 10 in accordance with the user operation (S111 of FIG. 8). The service transfer request includes a user ID “minami” of a transferor user and a subscription service “video003” for identifying the service to be transferred, for example.

The service executing unit 13 of the comparison information utilization service device 10 having received the service transfer request generates a transfer assertion for asserting of a transferred service and a transferor user and sends the transfer assertion to the first user terminal 70 (S112). In the present exemplary embodiment, a transferred service “video003” and a transferor user “minami” are stored in the transfer assertion.

The first user terminal 70 having received the transfer assertion transmits the transfer assertion to the second user terminal 80 owned by the transferee user (S113). A means for transmitting the transfer assertion is not limited to communication via the network 60, but an infrared-ray communication (IrDA), a near-field radio communication, a non-contact reader/writer, and the like, incorporated into the user terminal can be used, for example.

The second user terminal 80 having received the transfer assertion from the first user terminal 70 by the operation of the transferor user transmits a service transfer execution request including the transfer assertion to the service executing unit 13 of the comparison information utilization service device 10 (S114). The service transfer execution request includes a user ID “minnami” which is a transferee, and a user ID “minami” which is a transferor and a subscription service “video003” representing a transferred service, included in the transfer assertion, for example.

The service executing unit 13 having received the transfer assertion sends an associated ID acquisition request to the associated ID utilizing unit 11 to acquire the associated IDs of both users, provided to the comparison information utilization service device 10 in order to acquire the associated IDs allowing the comparison information utilization service device 20, which is the user information comparison request destination, to identify the users with respect to the transferor user ID “minami” and the transferee user ID “minnami” (S115).

The associated ID utilizing unit 11 having received the associated ID acquisition request retrieves the associated IDs “fed0201” and “fed0023” from the transferor user ID “minami” and the transferee user ID “minnami,” respectively and sends the retrieved associated IDs to the service executing unit 13 (S116).

Subsequently, the service executing unit 13 having received the associated IDs of the transferor and transferee users from the associated ID utilizing unit 11 sends an associated ID acquisition request to the associated ID providing unit 51 of the associated ID providing device 50 to acquire the associated IDs stored in correlation in the user information comparing device 20 in order to acquire the associated IDs allowing the user information comparing device 20 of the transferor user and the transferee user using the associated IDs provided to the comparison information utilization service device 10 (S117). This request includes the associated IDs “fed0201” and “fed0023” (hereinafter referred to as associated IDs for an acquisition requestor server) stored in correlation in the comparison information utilization service device 10, of the transferor user and the transferee user, and a server ID (URL) “http://www.server002.com” representing the user information comparing device 20 which is an association destination server of the associated ID to be acquired, for example.

The associated ID providing unit 51 of the associated ID providing device 50 having received the associated ID acquisition request retrieves the associated ID for the acquisition requestor server stored in the request and a target associated ID from the acquisition destination server URL and sends back an associated ID for an acquisition destination server of the user designated by the associated ID for the acquisition requestor server to the comparison information utilization service device 10 which is the requestor (S118). In this example, the associated ID “fed0099” for the user information comparing device 20 is retrieved from the associated ID “fed0201” for the comparison information utilization service device 10 and the acquisition destination server URL “http://www.server002.com,” and the associated ID “fed0105” for the user information comparing device 20 is retrieved from the associated ID “fed0023” for the comparison information utilization service device 10 and the acquisition destination server URL “http://www.server002.com,” and the retrieved associated IDs “fed0099” and “fed0105” are sent back to the comparison information utilization service device 10.

The service executing unit 13 of the comparison information utilization service device 10 having received the associated IDs for the user information comparing device 20 from the associated ID providing unit 51 transmits a transfer condition determination request (in this example, means a user information comparison/determination request to the user information comparing device 20) requesting determination on whether the transferor user and the transferee user satisfy a transfer condition (S119). This request includes the associated ID “fed0099” for the user information comparing device 20, of the transferor user acquired from the associated ID providing device 50, the associated ID “fed0105” for the user information comparing device 20, of the transferee user, and “FAMILY” which is a transfer condition, for example.

The user information comparison/determination requesting unit 12 having received the transfer condition determination request transmits a user information comparison/determination request to the user information comparing device 20 using the transfer condition as the user information determination condition as it is (S120). The user information comparison/determination request includes user IDs (the user IDs which can be identified by the user information comparing device 20) representing two or more users of which the user information is to be compared and a comparison condition, for example. In this example, since the associated IDs acquired from the associated ID providing device 50 in steps S117 to S118 described above are already stored as the user IDs which can be identified by the user information comparing device 20, the associated ID “fed0099” for the user information comparing device 20, of the transferor user, the associated ID “fed0105” for the user information comparing device 20, of the transferee user, and “FAMILY” which is a transfer condition may be stored as they are. The processes of converting the user IDs in the comparison information utilization service device 10 into associated IDs which can be identified by the user information comparing device 20 (S115 to S118) may be performed by the user information comparison/determination requesting unit 12 in place of the service executing unit 13.

The user information comparing/determining unit 22 of the user information comparing device 20 having received the user information comparison/determination request sends a request to the associated ID utilizing unit 21 to acquire the user IDs in the user information comparing device 20 with respect to the respective associated IDs included in the request (S121). In this example, the user ID acquisition request includes the associated ID “fed0099” of the user of the first user terminal 70 which is a service transferor user and the associated ID “fed0105” of the user of the second user terminal 80 which is a service transferee.

The associated ID utilizing unit 21 of the user information comparing device 20 retrieves a user ID from the associated ID included in the request and sends back the retrieved user ID to the user information comparing/determining unit 22 (S122). In this example, a user ID “takeaki” is retrieved from the associated ID “fed0099,” a user ID “takao” is retrieved from the associated ID “fed0105,” and the retrieved user IDs are sent back to the user information comparing/determining unit 22 (see FIG. 4).

The user information comparing/determining unit 22 having received the user IDs from the associated ID utilizing unit 21 sends a request to the user information storage unit 23 to acquire the user information of a user designated by the user ID (S123). In this example, the user information acquisition request includes the user ID “takeaki” and the user ID “takao.”

The user information storage unit 23 retrieves user information (C232) correlated with a user ID (C231) as illustrated in FIG. 5 and sends back the retrieved user information to the user information comparing/determining unit (S124). In this example, user information (C232) including a reference user ID (C2321) “takao” and a relationship (C2322) “FATHER” is acquired from the user ID “takeaki” as the user information, user information (C232) including a reference user ID (C2321) “takeaki” and a relationship (C2322) “SON” is acquired from the user ID “takao,” and the acquired user information is sent back.

The user information comparing/determining unit 22 having received the user information determines whether a designated comparison condition (in this example, a transfer condition) is satisfied based on the acquired user information (S125) and sends back the determination result thereof to the user information comparison/determination requesting unit 12 of the comparison information utilization service device 10 which is the requestor (S126). In this example, since the comparison condition is “FAMILY,” and it can be confirmed that the users are of the same family from the reference user ID (C2321) and the relationship (C2322) included in the user information of the user ID “takeaki” and the user ID “takao”, the user information comparing/determining unit 22 sends back “comparison success” representing a note that the user IDs designated by the user information comparison/determination requesting unit 12 satisfy the comparison condition.

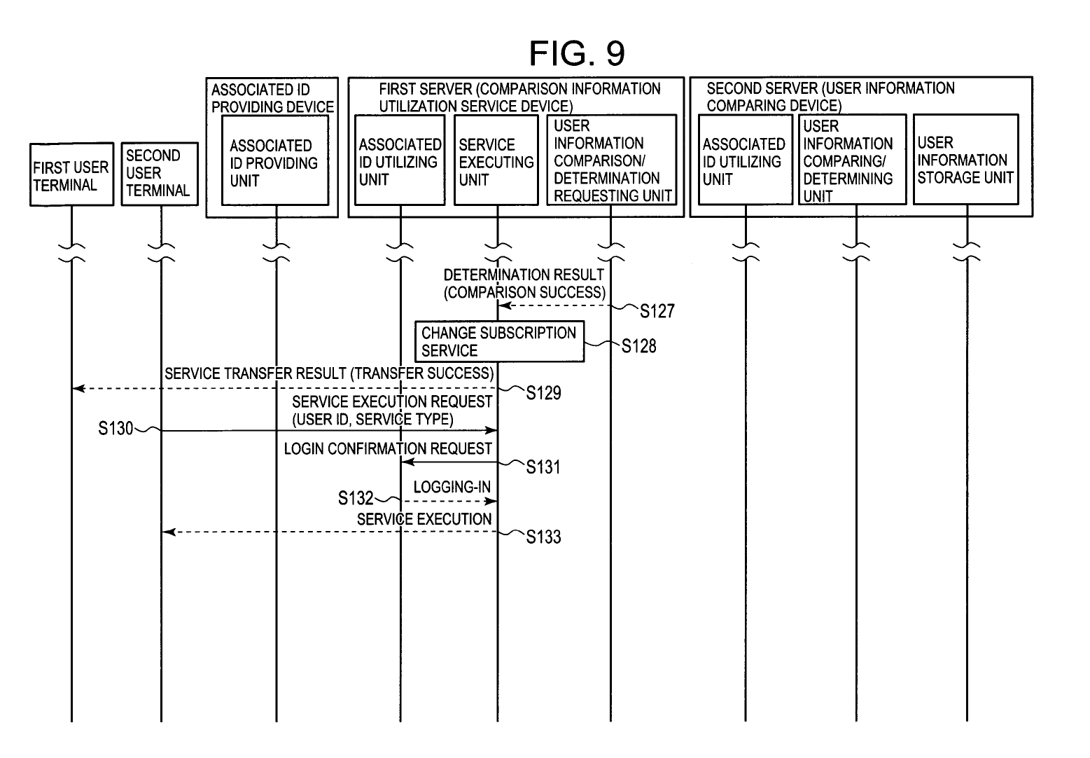

The user information comparison/determination requesting unit 12 of the comparison information utilization service device 10 having received the determination result sends back the determination result to the service executing unit 13 (S127 of FIG. 9).

If the determination result is “comparison success,” the service executing unit 13 having received the determination result rewrites the table in the service executing unit 13 in order to execute the transfer of service (S128) and sends back the transfer result to the first user terminal 70 of the transferor user (S129). In this example, in order to execute the transfer of service from the user ID “minami” to the user ID “minnami,” after rewriting the subscription service of the user ID “minami” and the subscription service of the user ID “minnami” in the table stored in the service executing unit 13 to “-” and “video003,” respectively (see D32 of FIG. 3(b)), a transfer result of service transfer success is sent back to the first user terminal 70. In this case, the transfer result of service transfer success may also be sent back to the second user terminal 80 of the transferee user. If the determination result is comparison fail, the service transfer process is not performed, and a transfer result of fail is sent back.

When the service transfer is successful, the transferred service becomes available in the second user terminal 80. Upon receiving the service transfer success, the second user terminal 80 may transmit a service execution request to the service executing unit 13 of the comparison information utilization service device 10 in accordance with the user operation, for example (S130). The service execution request includes the user ID “minnami” and a service “video003” of the user of the second user terminal 80, for example.

The service executing unit 13 transmits a login confirmation request to the associated ID utilizing unit 11 in order to check whether the user ID which is the requestor has been properly logging in (S131). The login confirmation request includes the user ID “minnami” transmitted from the second user terminal 80, for example.

The associated ID utilizing unit 11 determines whether the user indicated by the designated user ID has been logging in from the table (see FIG. 2) stored in the associated ID utilizing unit 11 and sends back the determination result to the service executing unit 13 (S132). In this example, since the associated ID “fed0023” corresponding to the user ID “minnami” is stored, the associated ID utilizing unit 11 determines that the designated user has been logging in and sends back a note indicating the user ID has been logging in to the service executing unit.

The service executing unit 13 having received the status that the use has been logging in determines whether the user has subscribed to the requested service (that is, the user has the right to receive the requested service), and provides the service designated to the second user terminal 80 which is the requestor when the user has subscribed (S133). In this example, since it can be determined that the user ID “minnami” has subscribed to the subscription service “video003” by referring to the table stored in the service executing unit 13, the service is executed in the second user terminal 80.

Although not described, when the service execution request is received from the first user terminal 70 using the user ID of the transferor after the service is transferred, since it is not possible to draw the subscription service “video003” from the user ID “minami,” it is determined that the user does not have the right to receive the service, and the requested service is not provided. In this way, it is recognized that the service has been transferred properly.

As above, according to the present exemplary embodiment, the comparison information utilization service device 10 can utilize the relationship between the users represented by user information without revealing (transmitting or receiving) the contents of the user information of the transferor user and the transferee user and the detailed data structure to the comparison information utilization service device 10.

Moreover, as advantageous effects to users, since the user information registered to one service provider can be reused for other service providers without providing the user information to the other service providers, the users can receive a personalized service more reliably.

### Second Exemplary Embodiment

Next, a second exemplary embodiment of the present invention will be described. In the following description, an example in which in a table booking service of restaurants using emails, the person who booked the restaurant is transferred from a child to a father is described. Here, the table booking service of restaurants is a service which allows anonymous communication such as sending an announcement mail from a servant of the restaurant to a customer when the appointment day of the restaurant approaches, or conversely, sending a notice of change in the number of booked persons from a customer to the servant.

The service executing unit 13 of the first exemplary embodiment performs the process of distributing a moving image to a user terminal and the process of transferring a service. In the present exemplary embodiment, an executing unit of the service in which the restaurant executes a table booking service on customers is separated from an executing unit of an anonymous communication service of controlling a communication path between customers and the servant (restaurant) in order to execute and transfer the service. In this way, the executing unit of the table booking service can establish an application by focusing on a primary service without worrying about the control of communication with customers.

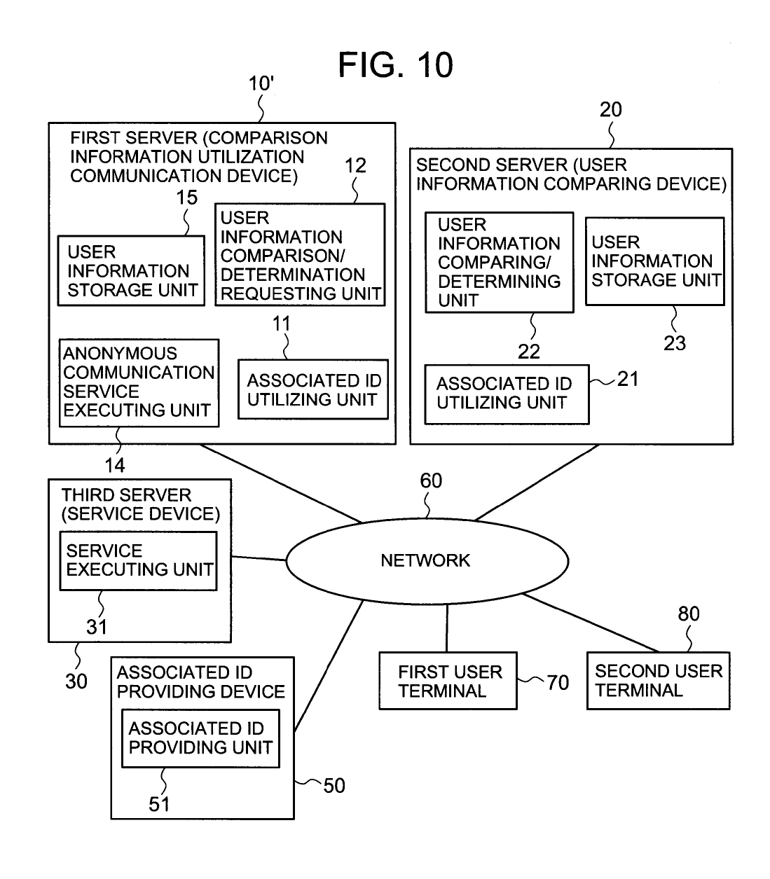

FIG. 10 is a block diagram illustrating a configuration example of a user information utilization system according to the second exemplary embodiment. The user information utilization system illustrated in FIG. 10 includes a first server 10, a second server 20, a third server 30, an associated ID providing device 50, a first user terminal 70, and a second user terminal 80. The respective devices are connected via a network 60 such as the Internet or a Next Generation Network (NGN). The connection to the network may be realized by a wired method or a wireless method. The number of user terminals may be one or three or more as long as it is a user terminal used by the user using the present system.

In the present exemplary embodiment, it is assumed that the first server 10′ (hereinafter referred to as a comparison information utilization communication device 10′) that performs the control of a communication path between a customer and a restaurant is operated by a mobile communication service provider or a fixed communication service provider. Moreover, it is assumed that the second server 20 (hereinafter referred to as a user information comparing device 20) that manages user information and provides a comparison/determination service is operated by an additional service provider that manages and operates user information. Moreover, it is assumed that the third server 30 (hereinafter referred to as a service device 30) is operated by a restaurant service provider that provides a table booking service.

Similarly to the first exemplary embodiment, the first user terminal 70 and the second user terminal 80 are information processing terminals such as a PC or a mobile phone. In the present exemplary embodiment, the user terminal performs communication with the service executing unit 31 of the service device 30 via a comparison information utilization communication device 10 described later using an email, an IP telephone function, or the like.

The comparison information utilization communication device 10′ is a server that performs the control of a communication path between users in a communication system including between customers and the restaurant as described above. The comparison information utilization communication device 10′ includes an associated ID utilizing unit 11, a user information comparison/determination requesting unit 12, an anonymous communication service executing unit 14, and a user information storage unit 15. Hereinafter, in order to distinguish the user information storage unit 15 from the user information storage unit 23 included in the user information comparing device 20, the user information storage unit 15 included in the comparison information utilization communication device 10′ is sometimes referred to as an anonymous communication user information storage unit 15.

The anonymous communication service executing unit 14 provides the first user terminal 70 and the second user terminal 80 with a temporary communication address (hereinafter referred to as a temporary address) for concealing a communication address (hereinafter referred to as a real address) such as the real telephone number or mail address of the corresponding user terminal to other service devices and performs an anonymous communication service. Moreover, a temporary address transfer process is performed in response to the request from the user terminal.

The anonymous communication user information storage unit 15 stores user information which is to be managed by a service provider operating the comparison information utilization communication device 10′. In the present exemplary embodiment, the anonymous communication user information storage unit 15 stores user information of respective users in correlation with the user ID in the comparison information utilization communication device 10′, for example. For example, the real address of a user is stored in correlation with the user ID. Moreover, in this example, it is assumed that the transfer condition of the temporary address of a communication counterpart user is stored for respective users.

The associated ID utilizing unit 11 and the user information comparison/determination requesting unit 12 are basically the same as those of the first exemplary embodiment. That is, the associated ID utilizing unit 11 stores an associated ID that correlates an (identifiable) user managed by the comparison information utilization communication device 10′ and a user managed by the associated ID providing device 50. In the present exemplary embodiment, the user ID in the comparison information utilization communication device 10′ and the associated ID provided from the associated ID providing device 50 in relation to the user ID are stored in correlation.

The user information comparison/determination requesting unit 12 sends a user information comparison/determination request to the user information comparing device 20. In the present exemplary embodiment, by the request from the anonymous communication service executing unit 14, the user information comparison/determination request is set to request the user information comparing device 20 to determine the relationship between the transferor user and the transferee user of the temporary address provided in the anonymous communication service.

Moreover, as described above, the service device 30 is a server that executes a table booking service of a certain restaurant, and includes a service executing unit 31. In the present exemplary embodiment, as for a user terminal that wants its real address to be concealed, the service executing unit 31 executes a table booking service via the comparison information utilization communication device 10′ having the anonymous communication service executing unit 14. In this example, the table booking service involves receiving access from users for receiving and changing booking and sending an announcement to customers who have booked using an email.

The associated ID providing device 50 and the user information comparing device 20 may be the same as those of the first exemplary embodiment.

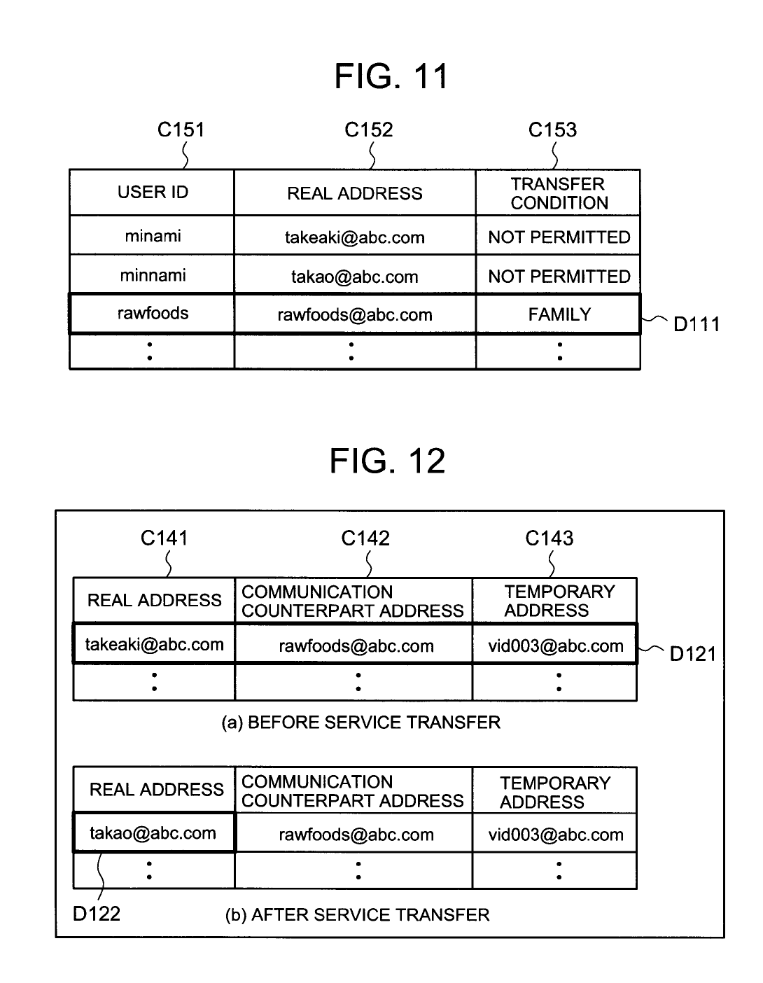

Next, the data stored in each unit of the present exemplary embodiment will be described. FIG. 11 is an explanatory diagram illustrating an example of the data stored in the anonymous communication user information storage unit 15 of the comparison information utilization communication device 10′. FIG. 11 illustrates an example of the structure of the data stored in the anonymous communication user information storage unit 15, which includes a user ID (C151) in the comparison information utilization communication device 10′, a real address (C152), and a transfer condition (C153). The transfer condition (C153) is a condition for permitting the transfer of the real address (C152) to the communication counterpart. FIG. 11 illustrates an example in which a user ID “minami,” a real address “takeaki@abc.com,” and a transfer condition “not permitted” are stored in correlation, for example. This shows that the real address serving as a means for contacting the user of the user ID “minami” is “takeaki@abc.com,” and the transfer of the temporary address of a communication counterpart of the real address “takeaki@abc.com” (namely, the user ID “minami”) is “not permitted.” Moreover, FIG. 11 illustrates an example in which a user ID “rawfoods,” a real address “rawfoods@abc.com,” and a transfer condition “FAMILY” are stored in correlation, for example. This shows that the real address serving as a means for contacting the user of the user ID “rawfoods” is “rawfoods@abc.com,” and the transfer condition of the temporary address of a communication counterpart of the real address “rawfoods@abc.com” (namely, the user ID “rawfoods”) is “FAMILY.” In other words, the temporary address used for communication with the real address “rawfoods@abc.com” may be transferred to other users if they are of the same family.

Moreover, FIG. 12 is an explanatory diagram illustrating an example of the data stored in the anonymous communication service executing unit 14 of the comparison information utilization communication device 10′. FIG. 12 illustrates an example of the structure of the data stored in the anonymous communication service executing unit 14, which includes a real address (C141), a communication counterpart address (C142), and a temporary address (C143). The real address (C141) is the real address of a user to which the anonymous communication service executing unit 14 provides the anonymous communication service. The communication counterpart address (C142) is a real communication address of a counterpart user communicating with the real address (C141). The temporary address (C143) is the temporary address presented to a communication counterpart in place of the real address (C141) of the user to which the anonymous communication service is provided.

The data stored in the other units are the same as those of the first exemplary embodiment.

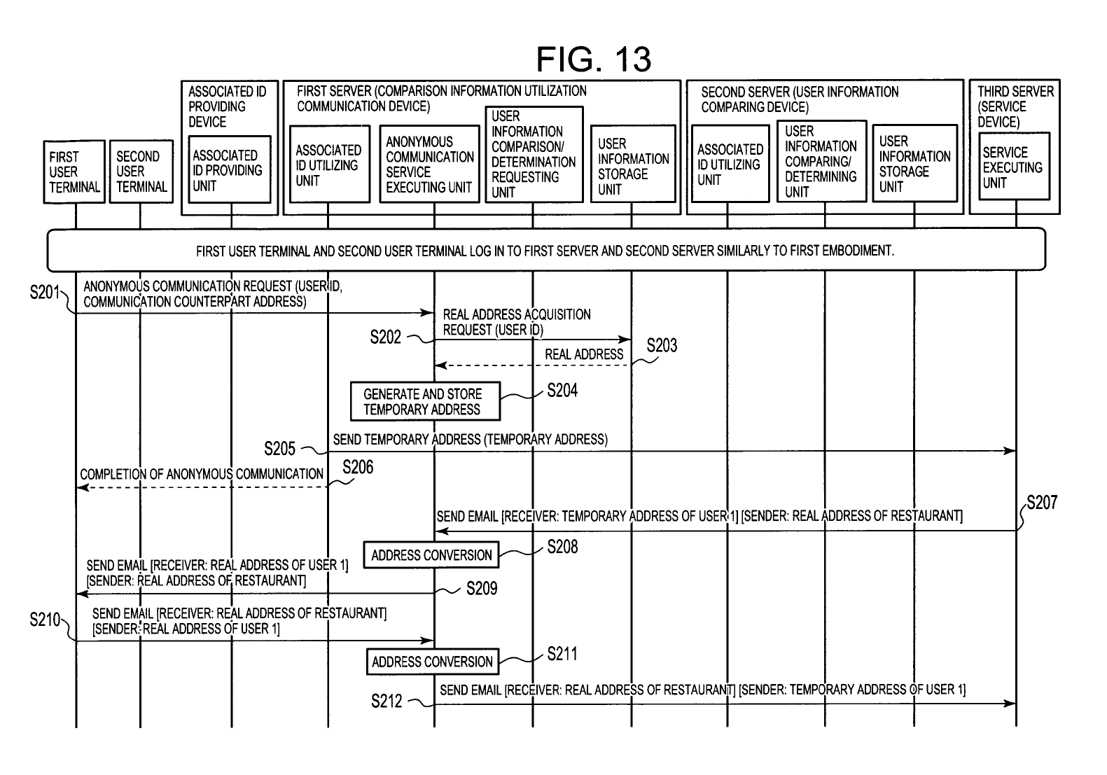

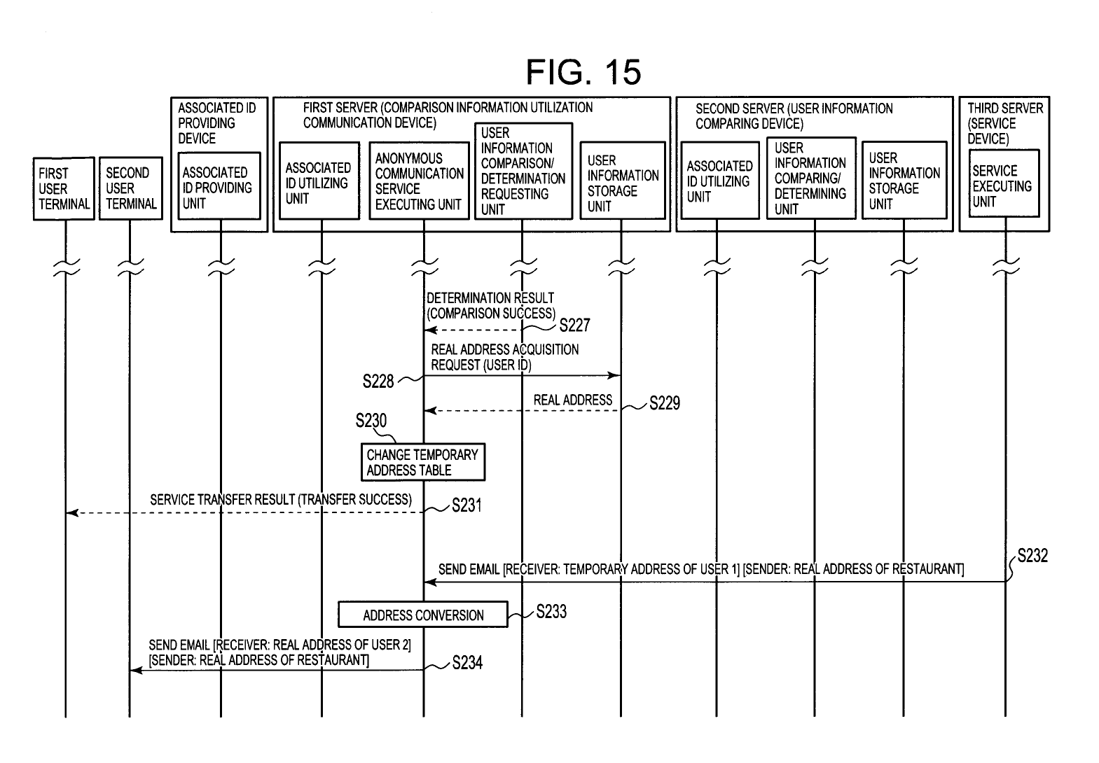

Next, the operation of the present exemplary embodiment will be described. FIGS. 13 to 15 are sequence diagrams illustrating an example of the operation of the present exemplary embodiment. FIGS. 13 to 15 are a series of sequence diagrams, and a message indicated by a broken-line arrow represents a response to a received request.

First, similarly to the first exemplary embodiment, the first user terminal 70 and the second user terminal 80 performs a login process via the associated ID providing device 50 with respect to the comparison information utilization communication device 10′ and the user information comparing device 20, respectively (see S101 to S106 of FIG. 7).

In this way, an ID association is performed between the associated ID providing device 50 and the comparison information utilization communication device 10′, and the ID association is performed between the associated ID providing device 50 and the user information comparing device 20. As a result, similarly to the first exemplary embodiment, the data as illustrated in FIG. 6 are created in the associated ID providing unit 51 of the associated ID providing device 50, the data as illustrated in FIG. 2 are created in the associated ID utilizing unit 11 of the comparison information utilization communication device 10′, and the data as illustrated in FIG. 4 are created in the associated ID utilizing unit 21 of the user information comparing device 20.

Subsequently, the first user terminal 70 sends an anonymous communication request to the comparison information utilization communication device 10′ in order to receive the table booking service of the associated ID 30 anonymously (S201). The anonymous communication request includes a communication address “rawfoods@abc.com” of the service device 30 serving as a communication counterpart and a user ID “minami” of the first user terminal 70, for example.

The anonymous communication service executing unit 14 of the comparison information utilization communication device 10′ having received the anonymous communication request sends a real address acquisition request to the anonymous communication user information storage unit 15 in order to acquire the real address from the user ID of the requestor (S202). The anonymous communication user information storage unit 15 retrieves the corresponding user information from the designated user ID and sends back the real address to the anonymous communication service executing unit 14 (S203). In this example, “takeaki@abc.com” is sent back as the real address corresponding to the user ID “minami” (see FIG. 11).

The anonymous communication service executing unit 14 having received the response to the real address acquisition request generates a temporary address corresponding to the acquired real address, stores the temporary address in a table (hereinafter referred to as a temporary address table) stored in the anonymous communication service executing unit 14 (S204), and notifies (sends) the generated temporary address to the service device 30 corresponding to the user (communication counterpart) (S205). In this example, “vid003@abc.com” is generated as the temporary address provided to the communication counterpart address “rawfoods@abc.com” of the real address “takeaki@abc.com” and stored in the temporary address table (see D121 of FIG. 12), and the stored temporary address “vid003@abc.com” is presented to the service executing unit 31 of the service device 30. The temporary address may be generated using a random number or the like whenever a request is received, and one of the communication addresses prepared in advance may be selected and set.

Moreover, the anonymous communication service executing unit 14 sends a response indicating that the temporary address has been presented to the communication counterpart to the first user terminal 70 which is the requestor (S206).

After that, the service executing unit 31 of the service device 30 having been presented with the temporary address can contact the first user terminal 70 using the notified temporary address. For example, the service executing unit 31 can send an email in which a temporary address “vid003@abc.com” is designated as a receiver address, and the real address “rawfoods@abc.com” of the service device 30 is designated as the address of the sender (S207).

The email is first delivered to the anonymous communication service executing unit 14 of the comparison information utilization communication device 10′. The anonymous communication service executing unit 14 having received the email performs address conversion for performing anonymous communication by referring to the temporary address table stored therein.

In the present exemplary embodiment, the following rules are used as the address conversion rule.

Rule A

When the receiver address of the received email is identical to the temporary address (C143), and the sender address is identical to the communication counterpart address (C142), the receiver address is converted to the content (real address) of the real address (C141) of the matched record.

Rule B

When the receiver address of the received email is identical to the communication counterpart address (C142), and the sender address is identical to the real address (C141), the sender address is converted to the content (temporary address) of the temporary address (C143) of the matched record.

Rule C

If any of these rules is not satisfied, transmission of an email is rejected.

When the address conversion rules are applied, since the receiver address “vid003@abc.com” is identical to the temporary address (C143) of D121 of FIG. 12, and the sender address “rawfoods@abc.com” is identical to the communication counterpart address (C142) of D121 of FIG. 12, Rule A is applied. Thus, the receiver address of the received email is converted from “vid003@abc.com” to the real address (C141) “takeaki@abc.com,” and then, the email is transmitted to the first user terminal 70 (S209).

Moreover, conversely, when an email is transmitted from the first user terminal 70 to the service executing unit 31 of the service device 30, the email may be transmitted by designating the real address “rawfoods@abc.com” of the service device 30 as the receiver address and designating the real address “takeaki@abc.com” of the first user terminal 70 as the sender address (S210). The anonymous communication service executing unit 14 having received the email performs address conversion for performing anonymous communication by referring to the temporary address table stored therein in a manner similar to the above.

In this example, since the receiver address “rawfoods@abc.com” is identical to the communication counterpart address (C142) of D121 of FIG. 12, and the sender address “takeaki@abc.com” is identical to the real address (C141) of D121 of FIG. 12, Rule B is applied. Thus, the sender address of the received email is converted from “takeaki@abc.com” to the temporary address (C143) “vid003@abc.com,” and then the email is transmitted to the service device 30 (S212).

In this way, the email transmitted from the service device 30 to the first user terminal 70 and the email transmitted from the first user terminal 70 to the service device 30 can be transmitted while concealing the real address of the first user terminal 70 to the service device 30.

Next, the user of the first user terminal 70 performs an operation of transferring the anonymous table booking service received from the service device 30 to another user (in this example, a father). More specifically, the user performs an operation of transferring the temporary address (more specifically the temporary address in which the service device 30 is the communication counterpart) for the anonymous communication service of the comparison information utilization communication device 10′ that performs the anonymous table booking service.

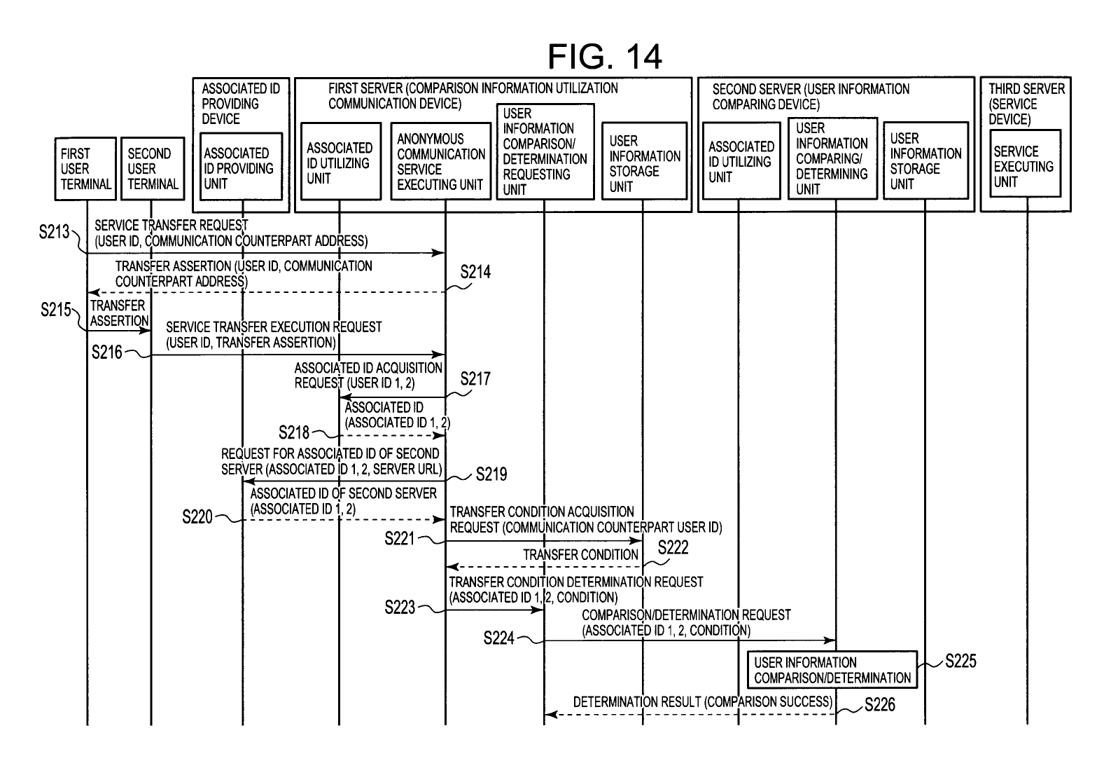

When the operation for issuing a service transfer request is performed, the first user terminal 70 sends the service transfer request to the comparison information utilization communication device 10′ (S213 of FIG. 14). The service transfer request may be issued via a menu screen for anonymous communication service which is downloaded by accessing the comparison information utilization communication device 10′, for example. The service transfer request includes the user ID “minami” of the transferor user and the communication counterpart address “rawfoods@abc.com” that uses the anonymous communication service, for example.

The anonymous communication service executing unit 14 having received the service transfer request generates a transfer assertion for asserting a transferred service and a transferor user and sends the transfer assertion to the first user terminal 70 (S214). In the present exemplary embodiment, a communication counterpart address “rawfoods@abc.com” and a transferor user “minami” are stored in the transfer assertion.

The first user terminal 70 having received the transfer assertion sends the transfer assertion to the second user terminal 80 owned by the transferee user (S215). A means for transmitting the transfer assertion is not limited to communication via the network 60, but an infrared-ray communication (IrDA), a near-field radio communication, a non-contact reader/writer, and the like, incorporated into the user terminal can be used, for example.

The second user terminal 80 having received the transfer assertion sends a service transfer execution request including the transfer assertion to the anonymous communication service executing unit 14 of the comparison information utilization communication device 10′ (S216). In the present exemplary embodiment, the user ID “minnami” of the transferee user having transmitted the service transfer execution request is also sent together with the transfer assertion.

The anonymous communication service executing unit 14 having received the service transfer execution request sends an associated ID acquisition request to the associated ID utilizing unit 11 to acquire the associated IDs of both users, provided to the comparison information utilization communication device 10′ in order to acquire the associated IDs allowing the comparison information utilization service device 20, which is the user information comparison request destination, to identify the users with respect to the transferor user ID “minami” stored in the transfer assertion and the transferee user ID “minnami” determined from the sender of the transfer assertion (S217). The associated ID acquisition operations of S217 to S220 are the same as the operations of S115 to S118 of the first exemplary embodiment, and description thereof will not be provided.

Upon receiving the transferor user and the associated ID of the transferee user, which can be identified by the user information comparing device 20 from the associated ID providing device 50 (S220), the anonymous communication service executing unit 14 of the comparison information utilization communication device 10′ sends a transfer condition acquisition request to the anonymous communication user information storage unit 15 in order to acquire the transfer condition registered in the user information, that is the comparison condition corresponding to the condition that the service executing unit 31 of the service device 30 permits the transfer of a communication destination related to the table booking service (S221). In this example, the real address “rawfoods@abc.com” to the service executing unit 31 of the service device 30 which is the communication counterpart is designated.

The anonymous communication user information storage unit 15 having received the request retrieves the transfer condition from the designated real address and sends back the retrieved transfer condition to the anonymous communication service executing unit 14 (S222). In this example, the transfer condition “FAMILY” is retrieved from the real address “rawfoods@abc.com” and sent back (see D111 of FIG. 11).

Upon acquiring the transfer condition, the anonymous communication service executing unit 14 sends a transfer condition determination request (in this example, means a user information comparison/determination request to the user information comparing device 20) requesting determination on whether the transferor user and the transferee user satisfy a transfer condition similarly to the service executing unit 13 of the first exemplary embodiment to the user information comparison/determination requesting unit 12 (S223). The comparing/determining operations of S223 to S226 are the same as the operations of S119 to S126 of the first exemplary embodiment, and description thereof will not be provided. Although the sequence corresponding to S121 to S124 is not illustrated in FIG. 11, these operations are performed similarly.

As a result of the comparison and determination, the anonymous communication service executing unit 14 receives “comparison success” from the user information comparison/determination requesting unit 12 as the determination result (S227).

The anonymous communication service executing unit 14 having received “comparison success” sends a request to the anonymous communication user information storage unit 15 to acquire the real address of the transferee user (S228). This request includes the user ID “minnami” which is the transferee of the communication service.

The anonymous communication user information storage unit 15 having received the request retrieves the real address from the user ID with respect to the user information stored therein and sends back the retrieved real address to the anonymous communication service executing unit 14 (S229). In this example, the real address “takao@abc.com” is retrieved from the user ID “minnami” and sent back to the anonymous communication service executing unit 14.

The anonymous communication service executing unit 14 having received the real address of the transferee user rewrites the content of the real address (C141) correlated with the temporary address to be transferred into the real address of the transferee user acquired from the real address of the transferor user in the temporary address table stored therein (S230) and sends the transfer result to the first user terminal 70 of the transferor user (S231). In this example, the real address (C141) of the corresponding record in the temporary address table is rewritten from “takeaki@abc.com” to “takao@abc.com” (see D122 of FIG. 12B).

When the temporary address transfer process is completed, the service executing unit 31 of the service device 30 sends an email in which the temporary address “vid003@abc.com” of the first user terminal 70 which is identified by the service device 30 is designated as the receiver address, and “rawfoods@abc.com” is designated as the sender address (S231). Then, the anonymous communication service executing unit 14 of the comparison information utilization communication device 10′ having received the email performs address conversion for performing anonymous communication by referring to the temporary address table (S233). In this example, since the temporary address table is updated by the transfer process, when the address conversion rule described above is applied, the receiver address “vid003@abc.com” is identical to the temporary address (C143), and the sender address “rawfoods@abc.com” is identical to the communication counterpart address (C142). Thus, Rule A is applied. Therefore, the receiver address is converted from “vid003@abc.com” to the registered real address “takao@abc.com”, and then, the email is transmitted (S234). In this case, the receiver address is converted to the real address of the second user terminal 80 which is the service transferee.

As above, in the present exemplary embodiment, it is possible to separate the process of the service executing unit 31 that executes a service in which the restaurant executes the table booking service on customers from the process of the anonymous communication service executing unit 14 that controls a communication path between customers and the servant in order to transfer the table booking service.

### Third Exemplary Embodiment

Next, a third embodiment of the present invention will be described.

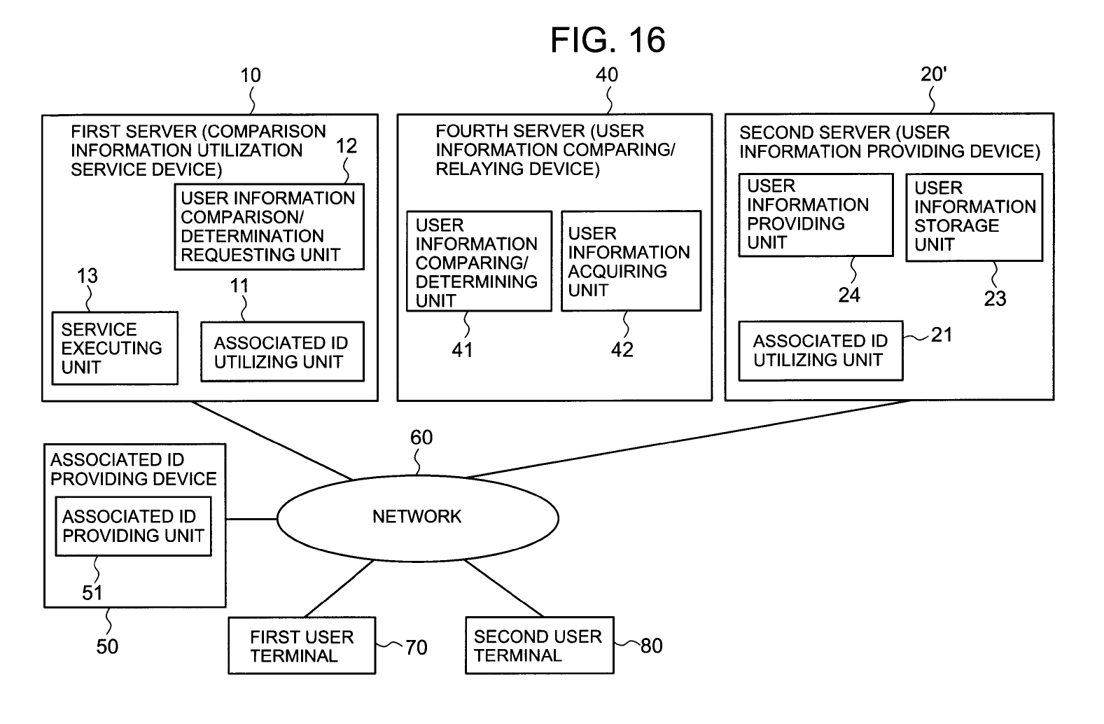

FIG. 16 is a block diagram illustrating a configuration example of a user information utilization system according to the third embodiment. The user information utilization system illustrated in FIG. 16 includes a first server 10, a second server 20′, a fourth server 40, an associated ID providing device 50, a first user terminal 70, and a second user terminal 80. The respective devices are connected via a network 60 such as the Internet or a Next Generation Network (NGN). The connection to the network may be realized by a wired method or a wireless method. The number of user terminal may be one or three or more as long as the user terminal is a user terminal used by the user using the present system.

In the following description, similarly to the first embodiment, an example in which the right of a one-week free access video service is transferred from a child to a parent utilizing the user information will be described. The difference from the first embodiment is that the fourth server (hereinafter referred to as a user information comparing/relaying device 40) that relays and processes a comparison request is provided between the first server 10 (hereinafter referred to as a comparison information utilization service device 10) that provides a video service and the second server 20′ (hereinafter referred to as a user information providing device 20′). In the present embodiment, although the user information is exchanged between the user information providing device 20′ and the user information comparing/relaying device 40, these exchanges are performed in a robust security environment under restrictions.

The user information comparing/relaying device 40 includes a user information comparing/determining unit 41 and a user information acquiring unit 42. The user information comparing/determining unit 41 provides a comparison/determination service with respect to the user information managed by the user information providing device 20′ in response to the request from the comparison information utilization service device 10. The user information acquiring unit 42 acquires the user information, that is, the user information to be compared, required when the user information comparing/determining unit 41 performs the comparison/determination service from the user information providing device 20′.

Moreover, the user information providing device 20′ includes an associated ID utilizing unit 21, a user information storage unit 23, and a user information providing unit 24. The associated ID utilizing unit 21 and the user information storage unit 23 are the same as the associated ID utilizing unit 21 and the user information storage unit 23 of the first embodiment. The user information providing unit 24 provide the user information managed by the user information providing device 20′ in response to the request from the user information comparing/relaying device 40.

Moreover, in the present exemplary embodiment, the user information comparison/determination requesting unit 12 of the comparison information utilization service device 10 sends a comparison/determination request to the user information comparing/determining unit 41 of the user information comparing/relaying device 40, which was sent to the user information comparing/determining unit 22 of the user information comparing device 20. The other configuration is the same as that of the first exemplary embodiment.

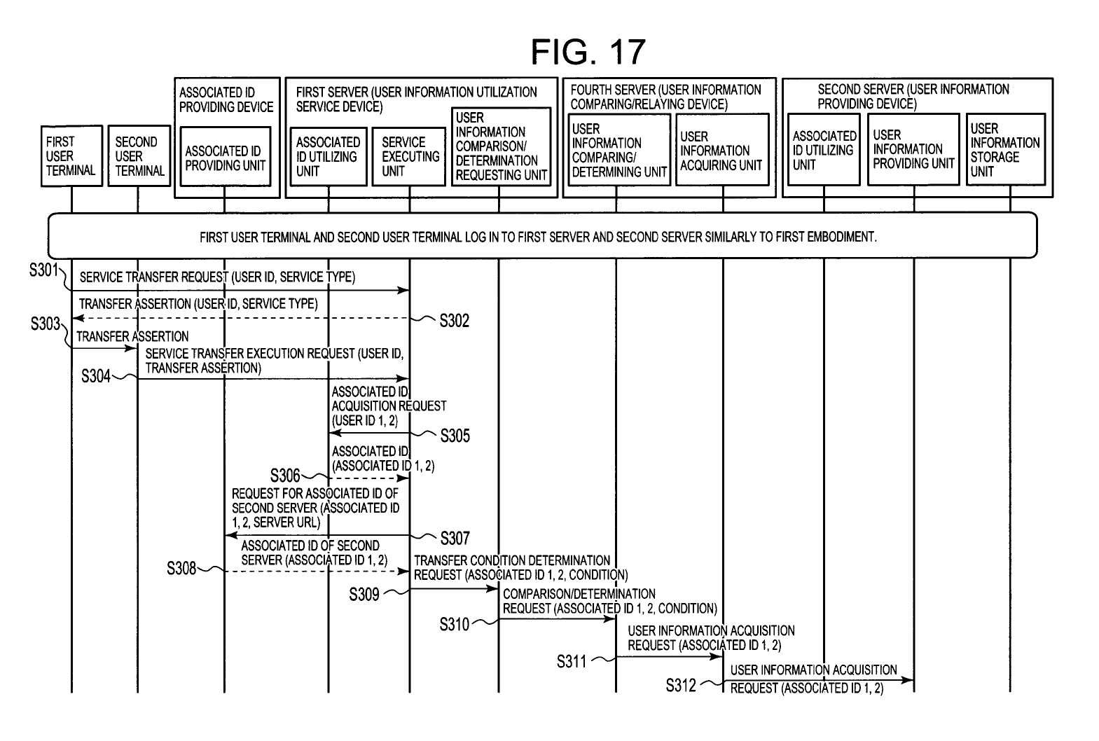

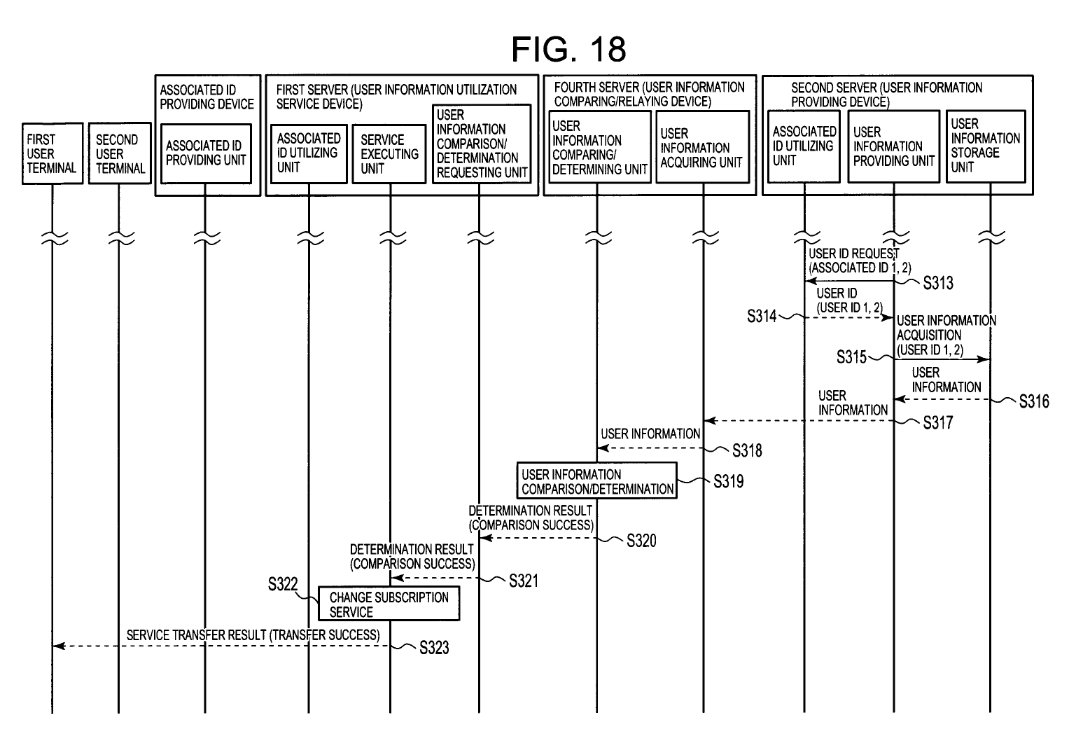

Next, the operation of the present exemplary embodiment will be described. FIGS. 17 and 18 are sequence diagrams illustrating an example of the operation of the present exemplary embodiment. FIGS. 17 and 18 are a series of sequence diagrams, and a message indicated by a broken-line arrow represents a response to a received request.

First, similarly to the first exemplary embodiment, the first user terminal 70 and the second user terminal 80 performs a login process via the associated ID providing device 50 with respect to the comparison information utilization service device 10 and the user information providing device 20′, respectively (see S101 to S106 of FIG. 7).

In this way, an ID association is performed between the associated ID providing device 50 and the comparison information utilization service device 10, and the ID association is performed between the associated ID providing device 50 and the user information providing device 20′. As a result, similarly to the first exemplary embodiment, the data as illustrated in FIG. 6 are created in the associated ID providing unit 51 of the associated ID providing device 50, the data as illustrated in FIG. 2 are created in the associated ID utilizing unit 11 of the comparison information utilization service device 10, and the data as illustrated in FIG. 4 are created in the associated ID utilizing unit 21 of the user information providing device 20′.

Subsequently, the first user terminal 70 sends a service execution request to the comparison information utilization service device 10 in order to receive a video service of the comparison information utilization service device 10. The operation related to execution of the video service is the same as that of S107 to S110 of the first exemplary embodiment, illustration and description thereof will not be provided.

Subsequently, the user of the first user terminal 70 performs an operation of transferring the service received from the comparison information utilization service device 10 to another user. In the present exemplary embodiment, an example in which the right of a one-week free access video service is transferred from a child to a parent will be described.

The operations of S301 to S309 among the operations related to the service transfer process are the same as those of S111 to S119 of the first exemplary embodiment, and description thereof will not be provided.

In the present exemplary embodiment, the user information comparison/determination requesting unit 12 having received the transfer condition determination request transmits a user information comparison/determination request to the user information comparing/relaying device 40 (S310).

The user information comparing/determining unit 41 of the user information comparing/relaying device 40 having received the user information comparison/determination request transmits a user information acquisition request to the user information acquiring unit 42 in order to acquire the user information to be compared (S311). The user information acquisition request includes information capable of identifying acquisition target users, for example. In the present invention, the number of acquisition target users is two or more. The user information comparing/determining unit 41 may store two or more user IDs representing acquisition target users in one user information acquisition request, and may transmit a user information acquisition request including one user ID a plurality of number of times. In this example, it is assumed that the user information acquisition request includes an associated ID “fed0099” of the first user terminal 70 and an associated ID “fed0105” of the second user terminal 80.

The user information acquiring unit 42 having received the user information acquisition request sends a user information acquisition request to the user information providing device 20′ in order to acquire the user information of a designated user (S312). The user information comparison/determination request includes user IDs (the user IDs which can be identified by the user information providing device 20′) representing two or more users of which the user information is to be compared. In this example, since the associated IDs acquired from the associated ID providing device 50 are already stored as the user IDs which can be identified by the user information providing device 20′, the associated ID “fed0099” for the user information comparing device 20, of the transferor user and the associated ID “fed0105” for the user information comparing device 20, of the transferor user may be stored as they are. The user information comparing/relaying device 40 may perform the processes (S307 and S308) of receiving the user information comparison request in which the associated ID identified by the comparison information utilization service device 10 is stored and sending a request for the associated ID for the user information providing device 20′ to the associated ID providing device 50 based on the associated ID.

The user information providing unit 24 of the user information providing device 20′ having received the user information acquisition request from the user information comparing/relaying device 40 sends a user ID request to the associated ID utilizing unit 21 in order to acquire the user ID in the user information comparing device 20′ corresponding to the designated associated ID (S321). Since the operations (S313 to S316) related to acquisition of user information from the associated ID are the same as those of S121 to S124 of the first exemplary embodiment, description thereof will not be provided. In this example, as the user information, information including the reference user ID “takao” and the relationship “FATHER” is acquired from the user ID “takeaki,” and information including the reference user ID “takeaki” and the relationship “SON” is acquired from the user ID “takao.”

The user information providing unit 24 having received the user information sends back the acquired user information to the user information comparing/relaying device 40 as a response to the request of S312 (S317).

The user information acquiring unit 42 of the user information comparing/relaying device 40 having received the user information sends back the acquired user information to the user information comparing/determining unit 41 as a response to the request of S311 (S318).

Similarly to the user information comparing/determining unit 22 of the first exemplary embodiment, the user information comparing/determining unit 41 having received the user information determines whether the acquired user information satisfies a comparison condition (S319) and sends back the determination result to the comparison information utilization service device 10 as a response to the request of S310 (S320). In this example, since the comparison condition is “FAMILY,” and it can be confirmed that the users are of the same family from the user information of the user ID “takeaki” and the user ID “takao,” the user information comparing/determining unit 41 sends back “comparison success” as a response.

The user information comparison/determination requesting unit 12 of the comparison information utilization service device 10 having received the determination result sends back the acquired determination result to the service executing unit 13 as a response to the request of S309 (S321).

Similarly to the first exemplary embodiment, when the determination result is comparison success, the service executing unit 13 having received the determination result rewrites the table of the service executing unit in order to execute the transfer of service (S322) and sends back the transfer result to the first user terminal 70 (S323). If the determination result is comparison fail, the service transfer process is not performed, and a transfer result of fail is sent back.

As above, according to the present exemplary embodiment, it is possible to conceal the content of the user information possessed by the user information providing device 20′ to the comparison information utilization service device 10 and conceal the comparison condition used by the comparison information utilization service device 10 to the user information providing device 20′.

In the respective exemplary embodiments, although an example in which the user information of two users is used as an example of the comparison target user information, the user information of three of more users may be used as the comparison target user information. For example, when a condition that “the users are members of the same company” is defined as a subscription condition to a certain service, and a number of users subscribe to the service at a time, the comparison determination may be performed with respect to these users using the condition that “the users are members of the same company” as the comparison condition. In such a case, the comparison result may be comparison success if the users are members of the same company, and otherwise, the comparison result may be comparison fail. Since the relationship between a plurality of users can be determined at a time, it is possible to lessen a network load.

As a method for allowing a comparison requestor device (service device or the like) to know a reference device (user information management device) for inquiring a comparison request or the interface thereof, the following standard functions can be used. As an example, Universal Description, Discovery and Integration (UDDI) which is the OASIS standard can be used. UDDI allows users to retrieve information on what service a Web service is, where it is located on a network, which interface it uses, and who its owner is. As another example, a device that stores user information may be retrieved using Discovery Service (DS) which is part of the functions of Identity Web Services Framework (ID-WSF) defined by Liberty Alliance.

Moreover, in the respective exemplary embodiments, although the servers have been described as independent devices, the respective servers may be configured as devices which are logically independent for respective service providers operating the servers. For example, one server may be realized by a plurality of devices having a RAID configuration, and may be realized by one system in which the servers of a plurality of service providers are in a cloud environment.

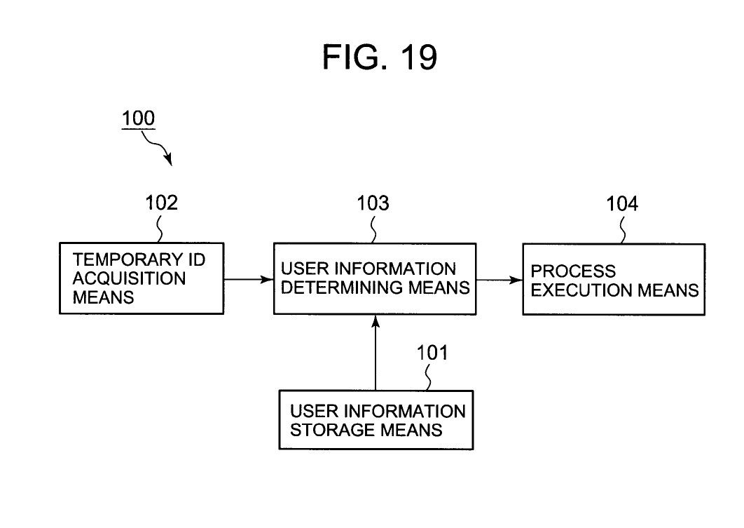

Hereinafter, an overview of the present invention will be described. FIG. 19 is a block diagram illustrating an overview of the present invention. A user information utilization system 100 illustrated in FIG. 19 includes: a user information storage means 101 (for example, the user information storage unit 23) that stores user information; a temporary ID acquisition means 102 (for example, the associated ID utilizing unit 11, 21) that acquires a temporary ID for identifying the identicalness of a user between a plurality of devices or a plurality of service providers, the temporary ID being an identifier corresponding to a user of the user information stored in the user information storage means; a user information determining means 103 (for example, the user information comparing/determining unit 22, 41) that receives two or more temporary IDs acquired by the temporary ID acquisition means and a predetermined condition representing a desired relationship between a plurality of users represented by the two or more temporary IDs and outputs a determination result representing whether the user information of the users corresponding to the received temporary IDs satisfies the predetermined condition; and a process execution means 104 (for example, the service executing unit 13 or the anonymous communication service executing unit 14) that receives the determination result on the user information by the user information determining means and executes a predetermined process based on the received determination result.

With this configuration, a service provider that wants to use user information in its service can use the user information without acquiring the user information. That is, the service provider can execute a predetermined process (for example, a process for performing services) by inputting only a comparison/determination result without inputting the user information.

(Supplementary note 1) A user information utilization system according to the present invention may include: a temporary ID providing device (for example, the associated ID providing device 50) that provides a temporary ID which is an identifier for identifying the identicalness of a user between a plurality of devices or a plurality of service providers; a user information determining device (for example, the user information comparing device 20) that provides a user information determination service; and a user information utilization device (for example, the comparison information utilization service device 10) that utilizes the determination service provided by the user information determining device, the user information determining device includes a user information storage means (for example, the user information storage unit 23) that stores user information, and a user information determining means (for example, the user information comparing/determining unit 22) that outputs a determination result representing whether the user information of a plurality of users read from the user information storage means satisfies the designated predetermined condition in response to a request, and the user information utilization device includes a temporary ID acquisition means (for example, the associated ID utilizing unit 11) that acquires a temporary ID corresponding to the user of the user information determining device from the temporary ID providing device, a user information determination requesting means (for example, the user information comparison/determination requesting unit 12) that sends a user information determination request to the user information determining device by designating two or more temporary IDs acquired by the temporary ID acquisition means and a predetermined condition representing a desired relationship between a plurality of users indicated by the two or more temporary IDs, and a process execution means (for example, the service executing unit 13) that executes a predetermined process based on the determination result on the user information obtained by the user information determination requesting means.

With this configuration, the user information utilization device can utilize the relationship between a plurality of users represented by the user information without acquiring the user information stored in the user information comparing/determining device when executing the service of the user information utilization device. Moreover, it is possible to easily acquire the temporary ID of a determination target user by using the temporary ID providing device that performs an ID association.

(Supplementary note 2) A user information utilization system according to the present invention may include: a temporary ID providing device (for example, the associated ID providing device 50) that provides a temporary ID which is an identifier for identifying the identicalness of a user between a plurality of devices or a plurality of service providers; a user information determining device (for example, the user information comparing device 20) that provides a user information determination service; a service providing device (for example, the service device 30) that provides a predetermined service to a user via communication with a user terminal owned by the user; and a communication path control device (for example, the comparison information utilization communication device 10′) that controls a communication path of the communication between the service providing device and the user terminal, the user information determining device includes a user information storage means (for example, the user information storage unit 23) that stores user information, and a user information determining means (for example, the user information comparing/determining unit 22) that outputs a determination result representing whether the user information of a plurality of users read from the user information storage means satisfies the designated predetermined condition in response to a request, and the communication path control device includes a temporary ID acquisition means (for example, the associated ID utilizing unit 11) that acquires a temporary ID corresponding to the user of the user information determining device from the temporary ID providing device, a user information determination requesting means (for example, the user information comparison/determination requesting unit 12) that sends a user information determination request to the user information determining device by designating two or more temporary IDs acquired by the temporary ID acquisition means and a predetermined condition representing a desired relationship between a plurality of users indicated by the two or more temporary IDs, and a communication service executing means (for example, the anonymous communication service executing unit 14) that changes a communication address used by the user of the communication path control device based on a determination result on the user information obtained by the user information determination requesting means.

The communication path control device is an exemplary embodiment of the user information utilization device. Moreover, the communication service executing means is an exemplary embodiment of the process execution means.

(Supplementary note 3) A user information utilization system according to the present invention may include: a temporary ID providing device (for example, the associated ID providing device 50) that provides a temporary ID which is an identifier for identifying the identicalness of a user between a plurality of devices or a plurality of service providers; a user information providing device (for example, the user information providing device 20′) that provides user information; a user information comparing/relaying device (for example, the user information comparing/relaying device 40) that receives user information from the user information providing device and provides a determination service of the user information; and a service providing device (for example, the comparison information utilization service device 10) that provides a predetermined service to users, the user information providing device includes a user information storage means (for example, the user information storage unit 23) that stores user information; and a user information providing means (for example, the user information providing unit 24) that provides user information of a designated user in response to a request from the user information comparing/relaying device, the service providing device or the user information comparing/relaying device includes a temporary ID acquisition means (for example, the associated ID utilizing unit 11) that acquires a temporary ID corresponding to the user of the user information providing device from the temporary ID providing device, the service providing device includes a user information determination requesting means (for example, the user information comparison/determination requesting unit 12) that sends a user information determination request to the user information comparing/relaying device by designating a temporary ID corresponding to the user of the service providing device or two or more temporary IDs acquired by the temporary ID acquisition means and a predetermined condition representing a desired relationship between a plurality of users indicated by the two or more temporary IDs, and a service executing means (for example, the service executing unit 13) that provides a service to users based on a determination result on the user information obtained by the user information determination requesting means, and the user information comparing/relaying device includes a user information acquiring means (for example, the user information acquiring unit 42) that acquires user information from the user information providing device, and a user information determining means (for example, the user information comparing/determining unit 41) that outputs a determination result representing whether the user information of a plurality of users read from the user information storage means satisfies the designated predetermined condition in response to a request from the service providing device.

The service providing device is an exemplary embodiment of the user information utilization device. Moreover, the service executing means is an exemplary embodiment of the process execution means. Moreover, in the configuration in which the user information comparing/relaying device includes the temporary ID acquisition means, when the designated temporary ID is the temporary ID corresponding to the user of the service providing device, the temporary ID corresponding to the user of the user information providing device may be acquired using the temporary ID acquisition means based on the designated temporary ID.

With this configuration, it is possible to conceal the content of the user information possessed by the user information providing device to the service providing device and conceal the condition designated by the service providing device as the determination condition to the user information providing device.

(Supplementary note 4) In the user information utilization system, the user information determining means may determine whether the relationship between a plurality of users satisfies the designated predetermined condition by referring to the user information of a plurality of users, read legitimately from the user information storage means in accordance with a user information comparison/determination request designating two or more temporary IDs acquired by the temporary ID acquisition means and a predetermined condition representing a desired relationship between a plurality of users indicated by the two or more temporary IDs and may output the determination result.

(Supplementary note 5) In the user information utilization system, the user information determination requesting means may send a request for a user information determination process by designating a predetermined condition stored in advance in correlation with the user of a user information utilization device that includes the user information determination requesting means.

(Supplementary note 6) In the user information utilization system, the user information determination requesting means may send a user information determination request to a user information comparing/relaying device by designating two or more temporary IDs corresponding to the user of a user information utilization device including the user information determination requesting means, provided from the temporary ID providing device and a predetermined condition representing a desired relationship between the plurality of users indicated by the two or more temporary IDs, and the user information comparing/relaying device may include a temporary ID acquisition means that acquires a temporary ID corresponding to the user of the user information providing device from the temporary ID providing device.

(Supplementary note 7) In the user information utilization system in which the user information storage means stores user information in correlation with a user identifier used in a device including the user information storage means, the user information utilization system may include a user identifier acquiring means that acquires a user identifier corresponding to a temporary ID included in the user information determination request.

(Supplementary note 8) In the user information utilization system, the process execution means included in the communication path control device may change a communication address used by the user of the communication path control device based on the determination result on the user information obtained by the request.

(Supplementary note 9) In the user information utilization system, the process execution means included in the communication path control device may change a temporary address which is a temporary communication address for concealing the real address of the user terminal owned by the user based on the determination result on the user information.

(Supplementary note 10) In the user information determining device according to the present invention, the user information determining means may determine whether the relationship between a plurality of users satisfies the designated predetermined condition by referring to the user information of a plurality of users, read legitimately from the user information storage means in accordance with a user information comparison/determination request designating two or more temporary IDs acquired by the temporary ID acquisition means and a predetermined condition representing a desired relationship between a plurality of users indicated by the two or more temporary IDs and may output the determination result.

(Supplementary note 11) In the user information determining device, the user information storage means stores user information in correlation with a user identifier used in a device including the user information storage means, and the user information determining device may include a user identifier acquiring means that acquires a user identifier corresponding to a temporary ID included in the user information determination request.

(Supplementary note 12) In the user information utilization device according to the present invention, the user information determination requesting means may send a request for a user information determination process by designating a predetermined condition stored in advance in correlation with the user of the user information utilization device.

(Supplementary note 13) In the user information utilization device, a communication path control device that controls a communication path of the communication between a user terminal and a service providing device that provides a predetermined service to a user via communication with the user terminal owned by the user, the process execution means may change a communication address used by the user of the communication path control device based on a determination result on user information obtained by a request.

(Supplementary note 14) The process execution means included in the communication path control device may change a temporary address which is a temporary communication address for concealing the real address of the user terminal owned by the user based on the determination result on the user information.

(Supplementary note 15) A user information utilization method according to the present invention may include: allowing a user information utilization device to acquire a temporary ID corresponding to the user of user information stored in the user information storage means from a temporary ID providing device using a temporary ID corresponding to the user of the user information utilization device provided from the temporary ID providing device that provides temporary IDs; and allowing the user information utilization device to send a request for a user information determination process to a user information permitting device using the acquired temporary ID.

The information processing device that wants to utilize the user information is the comparison information utilization service device 10 or the comparison information utilization communication device 10′ in the above-described exemplary embodiment, for example. Moreover, the user information permitting device which is the device capable of accessing the user information storage means that stores user information is the user information comparing device 20 or the user information comparing/relaying device 40 in the above-described exemplary embodiment, for example. Moreover, the user information providing device 20′ is also included.

(Supplementary note 16) In the user information utilization method, the user information utilization device may send the request for the user information determination process by designating a predetermined condition stored in advance in correlation with the user of the user information utilization device.

(Supplementary note 17) In the user information utilization method, the user information utilization device may send a user information determination request to a user information permitting device including a user information acquiring means that acquires user information from a user information providing device including a user information storage means, the user information permitting device may acquire the user information of a plurality of designated users from the user information storage means in response to the request from the user information utilization device, and the user information permitting device may output a determination result representing whether the acquired user information of the plurality of users satisfies the predetermined condition.

(Supplementary note 18) In the user information utilization method, the user information utilization device may send a user information determination request to a user information permitting device including a user information acquiring means that acquires user information from a user information providing device including a user information storage means by designating two or more temporary IDs corresponding to the user of the user information utilization device provided from a temporary ID providing device that provides temporary IDs and a predetermined condition representing a desired relationship between a plurality of users indicated by the two or more temporary IDs, the user information permitting device may acquire a temporary ID corresponding to the user of the user information stored in the user information storage means from the temporary ID providing device that provides temporary IDs using the designated temporary ID in response to the request from the user information utilization device, the user information permitting device may acquire the user information of the plurality of designated users from the user information storage means using the acquired temporary ID, and the user information permitting device may output a determination result representing whether the acquired user information of the plurality of users satisfy the predetermined condition.

(Supplementary note 19) In the user information utilization method, when the user information storage means stores user information in correlation with a user identifier used in a device including the user information storage means, the user information permitting device having received the request may acquire the user identifier corresponding to the temporary ID included in the user information determination request, and the user information permitting device may acquire the user information of the plurality of designated users from the user information storage means using the acquired user identifier.

(Supplementary note 20) In the user information utilization method, a user information utilization device which is a communication path control device that controls a communication path of the communication between a user terminal and a service providing device that provides a predetermined service to a user via communication with the user terminal owned by the user may change a communication address used by the user of the communication path control device based on a determination result on user information obtained by a request.

(Supplementary note 20) The communication path control device may change a temporary address which is a temporary communication address for concealing the real address of the user terminal owned by the user based on the determination result on the user information.

(Supplementary note 21) A user information determining program according to the present invention may allow a computer to execute a user information determination process of determining whether the relationship between a plurality of users satisfies the designated predetermined condition by referring to the user information of a plurality of users, read legitimately from the user information storage means in accordance with a user information comparison/determination request designating two or more temporary IDs acquired by the temporary ID acquisition means and a predetermined condition representing a desired relationship between a plurality of users indicated by the two or more temporary IDs and outputting the determination result.

(Supplementary note 22) The user information determining program may allow the computer to execute a user identifier acquisition process of acquiring a user identifier corresponding to the temporary ID included in the user information determination request when the user information storage means stores user information in correlation with the user identifier used in the device including the user information storage means.

(Supplementary note 23) A user information utilization program according to the present invention may allow a computer to execute a user information determination requesting process of sending a request for a user information determination process by designating a predetermined condition stored in advance in correlation with a user.

(Supplementary note 24) When applied to a communication path control device that controls a communication path of the communication between a user terminal and a service providing device that provides a predetermined service to a user via communication with the user terminal owned by the user, the user information utilization program may allow the computer to execute a communication address changing process of changing a communication address used by the user of the communication path control device based on a determination result on user information obtained by a request.

(Supplementary note 25) The user information utilization program may allow the computer to execute a communication address changing process of changing a temporary address which is a temporary communication address for concealing the real address of the user terminal owned by the user based on the determination result on the user information.

While the present invention has been described with reference to exemplary embodiments and examples, the present invention is not limited to the exemplary embodiments and examples described above. Various changes which are conceivable to those skilled in the art can be made to the configuration and details of the present invention within the scope of the present invention.

This application claims priority based on Japanese Patent Application No. 2009-298851, filed on Dec. 28, 2009, the entire contents of which are incorporated by reference herein.

### INDUSTRIAL APPLICABILITY

The present invention can be ideally applied to purposes of providing services using a relationship between users represented by user information of a plurality of users without providing the user information itself to a service provider.

### REFERENCE SIGNS LIST

10 Comparison information utilization service device
11, 21 Associated ID utilizing unit
12 User information comparison/determination requesting unit
13 Service executing unit
20 User information comparing device
22 User information comparing/determining unit
23 User information storage unit
50 Associated ID providing device
51 Associated ID providing unit
70 First user terminal
80 Second user terminal
10′ Comparison information utilization communication device
14 Anonymous communication service executing unit
15 User information storage unit (anonymous communication user information storage unit)
30 Service device
31 Service executing unit
40 User information comparing/relaying device
41 User information comparing/determining unit
42 User information acquiring unit
20′ User information providing device
24 User information providing unit
100 User information utilization system
101 Temporary ID acquisition means
102 User information determining means
103 Process execution means

1.-16. (canceled)

17. A user information utilization system comprising:
user information storage unit that stores user information;
temporary ID acquisition unit that acquires a temporary ID for identifying the identicalness of a user between a plurality of devices or a plurality of service providers, the temporary ID being an identifier corresponding to a user of the user information stored in the user information storage unit;
user information determining unit that receives two or more temporary IDs acquired by the temporary ID acquisition unit and a predetermined condition representing a desired relationship between a plurality of users represented by the two or more temporary IDs and outputs a determination result representing whether the user information of the users corresponding to the received temporary IDs satisfies the predetermined condition; and
process execution unit that receives the determination result on the user information by the user information determining unit and executes a predetermined process based on the received determination result.

18. The user information utilization system according to claim 17, comprising:
a temporary ID providing device that provides a temporary ID which is an identifier for identifying the identicalness of a user between a plurality of devices or a plurality of service providers;
a user information determining device that provides a user information determination service; and
a user information utilization device that utilizes the determination service provided by the user information determining device, wherein
the user information determining device includes
user information storage unit that stores user information, and
user information determining unit that outputs a determination result representing whether the user information of a plurality of users read from the user information storage unit satisfies the designated predetermined condition in response to a request, and
the user information utilization device includes
temporary ID acquisition unit that acquires a temporary ID corresponding to the user of the user information determining device from the temporary ID providing device,
user information determination requesting unit that sends a user information determination request to the user information determining device by designating two or more temporary IDs acquired by the temporary ID acquisition unit and a predetermined condition representing a desired relationship between a plurality of users indicated by the two or more temporary IDs, and
process execution unit that executes a predetermined process based on the determination result on the user information obtained by the user information determination requesting unit.

19. The user information utilization system according to claim 17, comprising:
a temporary ID providing device that provides a temporary ID which is an identifier for identifying the identicalness of a user between a plurality of devices or a plurality of service providers;
a user information determining device that provides a user information determination service;
a service providing device that provides a predetermined service to a user via communication with a user terminal owned by the user; and
a communication path control device that controls a communication path of the communication between the service providing device and the user terminal,
the user information determining device includes
user information storage unit that stores user information, and
user information determining unit that outputs a determination result representing whether the user information of a plurality of users read from the user information storage unit satisfies the designated predetermined condition in response to a request, and
the communication path control device includes
temporary ID acquisition unit that acquires a temporary ID corresponding to the user of the user information determining device from the temporary ID providing device,
user information determination requesting unit that sends a user information determination request to the user information determining device by designating two or more temporary IDs acquired by the temporary ID acquisition unit and a predetermined condition representing a desired relationship between a plurality of users indicated by the two or more temporary IDs, and
communication service executing unit that changes a communication address used by the user of the communication path control device based on a determination result on the user information obtained by the user information determination requesting unit.

20. The user information utilization system according to claim 17, comprising:
a temporary ID providing device that provides a temporary ID which is an identifier for identifying the identicalness of a user between a plurality of devices or a plurality of service providers;
a user information providing device that provides user information;
a user information comparing/relaying device that receives user information from the user information providing device and provides a determination service for the user ID; and
a service providing device that provides a predetermined service to users,
the user information providing device includes
user information storage unit that stores user information; and
user information providing unit that provides user information of a designated user in response to a request from the user information comparing/relaying device,
the service providing device or the user information comparing/relaying device includes
temporary ID acquisition unit that acquires a temporary ID corresponding to the user of the user information providing device from the temporary ID providing device,
the service providing device includes
user information determination requesting unit that sends a user information determination request to the user information comparing/relaying device by designating a temporary ID corresponding to the user of the service providing device or two or more temporary IDs acquired by the temporary ID acquisition unit and a predetermined condition representing a desired relationship between a plurality of users indicated by the two or more temporary IDs, and
service executing unit that provides a service to users based on a determination result on the user information obtained by the user information determination requesting unit, and
the user information comparing/relaying device includes
user information acquiring unit that acquires user information from the user information providing device, and
user information determining unit that outputs a determination result representing whether the user information of a plurality of users read from the user information storage unit satisfies the designated predetermined condition in response to a request from the service providing device.

21. A user information determining device capable of reading user information legitimately from a user information storage unit that stores user information, comprising:
user information determining unit that receives two or more temporary IDs which are identifiers for identifying the identicalness of a user between a plurality of devices or a plurality of service providers, the identifier corresponding to the user of the user information stored in the user information storage unit, and a predetermined condition representing a desired relationship between a plurality of users indicated by the two or more users and outputs a determination result representing whether the user information of the user corresponding to the received temporary ID satisfies the predetermined condition.

22. A user information utilization device capable of communicating with a user information determining device that legitimately acquires user information from a user information storage unit that stores user information and provides a user information determination service, comprising:
temporary ID acquisition unit that acquires a temporary ID for identifying the identicalness of a user between a plurality of devices or a plurality of service providers, the temporary ID being an identifier corresponding to a user of the user information stored in the user information storage unit;
user information determination requesting unit that sends a user information determination request to the user information determining device by designating two or more temporary IDs acquired by the temporary ID acquisition unit and a predetermined condition representing a desired relationship between a plurality of users indicated by the two or more temporary IDs; and
process execution unit that executes a predetermined process based on the determination result on the user information obtained by the user information determination requesting unit.

23. A user information utilization method comprising:
allowing a user information utilization device, which is an information processing device that wants to utilize user information, to send a user information determination request to a user information permitting device, which is an information processing device capable of accessing a user information storage means storing user information, by designating two or more temporary IDs which are identifiers for identifying the identicalness of a user between a plurality of devices or a plurality of service providers and a predetermined condition representing a desired relationship between a plurality of users indicated by the two or more temporary IDs;
allowing a user information permitting device having received the request to output a determination result representing whether the user information of the user corresponding to the designated temporary ID satisfies the predetermined condition as the user information determination process; and
allowing the user information utilization device to receive the determination result on the user information by the user information permitting device and execute a predetermined process based on the received determination result.

24. The user information utilization method according to claim 23, comprising:
allowing a user information utilization device to acquire a temporary ID corresponding to the user of user information stored in the user information storage means from a temporary ID providing device using a temporary ID corresponding to the user of the user information utilization device provided from the temporary ID providing device that provides temporary IDs; and
allowing the user information utilization device to send a user information determination request to a user information permitting device using the acquired temporary ID.

25. The user information utilization method according to claim 23,
wherein the user information utilization device sends the request for the user information determination process by designating a predetermined condition stored in advance in correlation with the user of the user information utilization device.

26. The user information utilization method according to claim 23, wherein
the user information utilization device sends a user information determination request to a user information permitting device including a user information acquiring means that acquires user information from a user information providing device including a user information storage means,
the user information permitting device acquires the user information of a plurality of designated users from the user information storage means in response to the request from the user information utilization device, and
the user information permitting device outputs a determination result representing whether the acquired user information of the plurality of users satisfies the predetermined condition.

27. The user information utilization method according to claim 23, wherein
the user information utilization device sends a user information determination request to a user information permitting device including a user information acquiring means that acquires user information from a user information providing device including a user information storage means by designating two or more temporary IDs corresponding to the user of the user information utilization device provided from a temporary ID providing device that provides temporary IDs and a predetermined condition representing a desired relationship between a plurality of users indicated by the two or more temporary IDs,
the user information permitting device acquires a temporary ID corresponding to the user of the user information stored in the user information storage means from the temporary ID providing device that provides temporary IDs using the designated temporary ID in response to the request from the user information utilization device,
the user information permitting device acquires the user information of the plurality of designated users from the user information storage means using the acquired temporary ID, and
the user information permitting device outputs a determination result representing whether the acquired user information of the plurality of users satisfies the predetermined condition.

28. The user information utilization method according to claim 23, wherein
the user information storage means stores user information in correlation with a user identifier used in a device including the user information storage means,
the user information permitting device having received the request acquires the user identifier corresponding to the temporary ID included in the user information determination request, and
the user information permitting device acquires the user information of the plurality of designated users from the user information storage means using the acquired user identifier.

29. The user information utilization method according to claim 23, wherein
a user information utilization device which is a communication path control device that controls a communication path of the communication between a user terminal and a service providing device that provides a predetermined service to a user via communication with the user terminal owned by the user changes a communication address used by the user of the communication path control device based on a determination result on user information obtained by a request.

30. The user information utilization method according to claim 29, wherein
the communication path control device changes a temporary address which is a temporary communication address for concealing the real address of the user terminal owned by the user based on the determination result on the user information.

31. A computer readable information recording medium storing a user information determining program for allowing a computer capable of legitimately reading user information from a user information storage means that stores user information, when executed,
receiving two or more temporary IDs corresponding to users of the user information stored in the user information storage means, provided from a temporary ID providing device that provides a temporary ID which is an identifier for identifying the identicalness of a user between a plurality of devices or a plurality of service providers and a predetermined condition representing a desired relationship between a plurality of users indicated by the two or more temporary IDs and
outputting a determination result representing whether the user information of the users corresponding to the received temporary IDs satisfies the predetermined condition.

32. A computer readable information recording medium storing a user information utilization program for allowing a computer capable of communicating with a user information determining device that legitimately acquires user information from a user information storage means that stores user information and provides a user information determination service, when executed,
a temporary ID acquisition processing for acquiring a temporary ID which is an identifier for identifying the identicalness of a user between a plurality of devices or a plurality of service providers, the identifier corresponding to a user of the user information stored in the user information storage means;
a user information determination requesting processing for sending a user information determination request to the user information determining device by designating two or more temporary IDs acquired by the temporary ID acquisition process and a predetermined condition representing a desired relationship between a plurality of users indicated by the two or more temporary IDs; and
a comparison/determination result receiving processing for receiving a determination result on the user information obtained by the request.
